(19) United States
(12) Patent Application Publication
(10) Pub. No.: US 2025/0310854 A1
(43) Pub. Date: Oct. 2, 2025

(54) Conditional Handover Including Conditional PSCell Change/Addition with Simultaneous Evaluation

(71) Applicant: Telefonaktiebolaget LM Ericsson (publ), Stockholm (SE)

(72) Inventors: Jens Bergqvist, Linköping (SE); Pontus Wallentin, Linköping (SE); Cecilia Eklöf, Täby (SE)

(21) Appl. No.: 19/112,473

(22) PCT Filed: Sep. 28, 2023
(86) PCT No.: PCT/SE2023/050961

§ 371 Date: Mar. 17, 2025

Related U.S. Application Data
(60) Provisional application No. 63/411,422, filed on Sep. 29, 2022.

(51) Int. Cl. H04W 36/36; H04W 36/30

(52) U.S. Cl. CPC H04W 36/362; H04W 36/305

(57) ABSTRACT

Methods and apparatuses resolve potential ambiguity when a UE is configured with multiple conditional operations. The UE may decode a Conditional Handover (CHO configuration at reception, and extract Conditional PSCell Change (CPC) and/or Conditional PSCell Addition (CPA) configurations, along with execution conditions, measurement configuration, and candidate PSCell identity bundled therein. Alternatively, the latter may be provided outside the CHO configuration, such as in RRC commands. Aspects include methods for the UE to determine the order of execution of different conditional configurations for which the execution conditions are fulfilled at the same time. In one aspect, the UE performs execution of CHO and CPA/CPC in a combined or a non-sequential (parallel) fashion. Aspects include methods for indicating that a conditional configuration is included within another conditional configuration between different network nodes, where the evaluation of the different conditional configurations are to be performed in parallel by the UE. Publication

### RELATED APPLICATIONS

This application claims priority to U.S. Provisional patent Application Ser. No. 63/411,422 filed 29 Sep. 2022, the entire contents of which are incorporated herein by reference.

### TECHNICAL FIELD

The present disclosure relates generally to wireless communication networks, and in particular to methods and apparatuses to optimize conditional execution of network operations.

### BACKGROUND

Wireless communication networks are ubiquitous in many parts of the world. These networks continue to grow in capacity and sophistication. To accommodate more users, different types of devices, and different use cases, the technical standards governing the operation of wireless communication networks continue to evolve. The Third Generation Partnership Project (3GPP) is a Standard Development Organization (SDO) that develops and promulgates technical standards (TS), in a series of numbered Releases (i.e., “Rel-n”). The fourth generation (4G) of network standards, known as Long Term Evolution (LTE) has been deployed, the fifth generation (5G), known as New Radio (NR) is in development and early stages of deployment, and the sixth generation (6G) is in conceptual design. With each generation, technological advances improve the capacity, robustness, and spectral efficiency of the wireless communication system. Also, as each generation of technology is deployed, specific standards are published controlling how equipment conforming to the different generational standards may interact, providing interoperability and seamless functionality from users' perspectives.

Mobility is a key feature of wireless communication systems. A fundamental architecture that supports User Equipment (UE) mobility, referred to as “cellular,” comprises a number of generally fixed base stations (eNG in LTE and gNB in NR), each providing wireless service to a large number of UE within an operating area, or cell. In carrier aggregation, a UE may connect to two or more cells, with its communications delegated among them. Hence, a UE may have a Primary Cell (PCell) and one or more Secondary Cells (SCells). In the case of multiple SCells, one of them may be designated as a Primary SCell (PSCell).

From the beginning, procedures have been defined to allow UEs to move between cells, performing “handover” (HO) operations to transfer service from a one base station to another. UEs periodically perform measurements on signals from neighboring base stations. As the signal quality of a currently-serving, or “source” base station degrades, and the signal quality of a neighboring “target” base station improves, the network and UE will cooperatively perform a HO from the source to the target base station, ideally without the user being aware of it.

However, if HO only occurs after a noticeable signal degradation from the source base station, radio conditions may already be so bad that further signaling with the source base station is not feasible, resulting in dropped coverage. Conditional HO (CHO) was introduced to avoid this result. In CHO, a UE is provided with one or more HO configurations in advance, along with execution conditions, when channel quality to the source base station is high. When the UE later measures the (degraded) channel and it meets the execution conditions, the UE may proceed with the HO operation towards the target base station, without further signaling to the source base station.

HO is not the only network mobility operation that can benefit from being preconfigured and conditionally executed by the UE. Conditional PSCell Change (CPC) and Conditional PSCell Addition (CPA) are examples of cell change/add procedures that may be predefined, and conditionally executed by UEs in response to measured conditions. When the UE is configured with multiple conditional operations, however, ambiguities may arise as to their execution. For example, the execution conditions for the CHO configuration are set by the source base station whereas the execution conditions for a CPC or CPA may be provided by the target base station. Another issue concerns the order of execution of CHO and CPC/CPA configurations when execution conditions are fulfilled for both at the same time, and both are to be executed. Furthermore, in some cases where a UE is configured with two conditional configurations that are both to be executed, one of the conditional configurations may include changes to the other conditional configuration. This may result in a proliferation of signaling, compared to configurations being executed together. The Background section of this document is provided to place aspects of the

present disclosure in technological and operational context, to assist those of skill in the art in understanding their scope and utility. Approaches described in the Background section could be pursued, but are not necessarily approaches that have been previously conceived or pursued. Unless explicitly identified as such, no statement herein is admitted to be prior art merely by its inclusion in the Background section.

### SUMMARY

The following presents a simplified summary of the disclosure in order to provide a basic understanding to those of skill in the art. This summary is not an extensive overview of the disclosure and is not intended to identify key/critical elements of aspects of the disclosure or to delineate the scope of the disclosure. The sole purpose of this summary is to present some concepts disclosed herein in a simplified form as a prelude to the more detailed description that is presented later.

According to aspects of the present disclosure described and claimed herein, a UE may obtain CPC or CPA configurations that are to be evaluated together with a CHO configuration, e.g., through an indication that the UE needs to decode (at reception of the configuration) both the CHO part (including at least the target PCell identity) and also the therein included CPC configuration, i.e., execution conditions and (possibly) measurement configuration and candidate PSCell identity in the CHO configuration.

In one aspect, the execution conditions, measurement configuration, and/or target PSCell identity for the CPC configuration(s) that is/are to be evaluated together with the CHO configuration are provided to the UE outside the CHO configuration. In one aspect, the target configuration, i.e., the RRCReconfiguration that the UE shall apply at execution of the CPC configuration, is however included within the CHO configuration. It is then only the execution conditions, measurement configuration, and/or target PSCell identity for the CPC configuration that is provided outside the CHO configuration.

Aspects of the present disclosure also include methods for the UE to determine the order of execution of different conditional configurations for which the execution conditions are fulfilled at the same time and where the procedures for both the configurations are to be executed, e.g., the order of execution of a CHO and a CPC or CPA procedure. In one example, the UE first executes the CHO configuration and then the CPC or CPA configuration (if the execution conditions have been fulfilled for any). This is for a case where the CPC/CPA configuration(s) are provided by the target MN of the CHO configuration, and thus can be assumed to be based on the target CHO configuration from that target MN. The CPC configuration could then possibly also include MCG updates, which could be a delta configuration based on the CHO configuration. However, it is also possible that the CPC configuration is based on the MCG configuration that the UE has before execution of the CHO configuration, e.g., in case the CPC configuration is set by the source MN. In that case, the UE should first execute the CPC configuration and then the CHO configuration (in which the SCG configuration, e.g., based on the executed CPC configuration, may be kept). In one aspect, the network provides an indication about what configuration to execute first. In another embodiment, the UE determines which configuration to execute first based on the method used to provide the different conditional configurations, e.g., whether the CPC or CPA configurations are provided within the CHO configuration (e.g., from the target MN) or outside the CHO configuration (e.g., from the source MN). In another aspect, the UE determines whether to execute CHO or CPC first based on criteria related to the current serving cells (e.g., PCell and PSCell).

In one aspect, the UE performs execution of CHO and CPA/CPC, in a combined or a non-sequential (parallel) fashion.

Aspects of the present disclosure also include methods for indicating that a conditional configuration is included within another conditional configuration between different network nodes, where the evaluation of the different conditional configurations are to be performed in parallel by the UE.

Aspects of the present disclosure also allow the UE to determine how to perform execution of two different conditional configurations that both fulfill execution conditions, and where both are to be executed.

One aspect relates to a method, performed by a wireless device operative in a wireless communication network, of performing multiple conditional operations. A target configuration including procedures for a Conditional Handover (CHO) and at least one of a Conditional PSCell Change (CPC) and a Conditional PSCell Addition (CPA) is received from the network. At least one measurement configuration, execution condition, and target PSCell identity for the CPC or CPA are received from the network. Network measurements are performed according to the measurement configuration. When the execution conditions are fulfilled, the associated operation(s) is/are performed).

Another aspect relates to a wireless device operative in a wireless communication network and capable of performing multiple conditional operations. The wireless device includes communication circuitry configured to communicate with the network, and processing circuitry operatively connected to the communication circuitry. The processing circuitry is configured to receive, from the network, a target configuration including procedures for a Conditional Handover (CHO) and at least one of a Conditional PSCell Change (CPC) and a Conditional PSCell Addition (CPA); receive, from the network, at least one measurement configuration, execution condition, and target PSCell identity for the CPC or CPA; perform network measurements according to the measurement configuration; and when the execution conditions are fulfilled, perform the associated operations.

Yet another aspect relates to a method, performed by a network node operative in a wireless communication network, wherein the network node is a candidate target Master Node (MN). A request for a Conditional Handover (CHO) for a wireless device is received from a source MN. One or more Conditional PSCell Change (CPC) or Conditional PSCell Addition (CPA) candidates are configured together with the CHO configuration. A CPC or CPA configuration is initiated towards one or more candidate target Secondary Nodes (SN). A target Secondary Cell Group (SCG) configuration for the CPC or CPA configuration is received from at least one candidate target SN. A response message including the configuration of CHO and CPC or CPA is transmitted to the source MN.

Still another embodiment relates to a network node operative in a wireless communication network, and configured as a candidate target Master Node (MN). The network node includes communication circuitry configured to communicate with the network, and processing circuitry operatively connected to the communication circuitry. The processing circuitry is configured to receive, from a source MN, a request for a Conditional Handover (CHO) for a wireless device; configure one or more Conditional PSCell Change (CPC) or Conditional PSCell Addition (CPA) candidates together with the CHO configuration;

initiate a CPC or CPA configuration towards one or more candidate target Secondary Nodes (SN) receive a target Secondary Cell Group, SCG, configuration for the CPC or CPA configuration from at least one candidate target SN; and transmit, to the source MN, a response message including the configuration of CHO and CPC or CPA.

### BRIEF DESCRIPTION OF THE DRAWINGS

The present disclosure will now be described more fully hereinafter with reference to the accompanying drawings, in which aspects of the disclosure are shown. However, this disclosure should not be construed as limited to the aspects set forth herein. Rather, these aspects are provided so that this disclosure will be thorough and complete, and will fully convey the scope of the disclosure to those skilled in the art. Like numbers refer to like elements throughout.

FIG. 1 is a diagram of Master and Secondary Cell Groups in a wireless network.

FIG. 2 is a block diagram showing Dual Connectivity to EPC.

FIG. 3 is a block diagram showing Dual Connectivity to 5GC.

FIG. 4 is a network signaling diagram for CHO.

FIG. 5 is a network signaling diagram for CPC.

FIG. 6 is a flow diagram of a method of performing multiple conditional operations by a wireless device.

FIG. 7 is a flow diagram of a method of CHO with CPC or CPA by a candidate target Master Node.

FIG. 8 is a hardware block diagram of a wireless device.

FIG. 9 is a functional block diagram of a wireless device.

FIG. 10 is a hardware block diagram of a network node.

FIG. 11 is a functional block diagram of a network node.

FIG. 12 is a block diagram of a communication system.

FIG. 13 is a block diagram of a UE.

FIG. 14 is a block diagram of a network node.

FIG. 15 is a block diagram of a host device.

FIG. 16 is a block diagram of a virtualization environment.

FIG. 17 is a block diagram of a host communicating via a network node with a UE over a partially wireless network connection.

### DETAILED DESCRIPTION

For simplicity and illustrative purposes, the present disclosure is described by referring mainly to an exemplary aspect thereof. In the following description, numerous specific details are set forth in order to provide a thorough understanding of the present disclosure. However, it will be readily apparent to one of ordinary skill in the art that the present disclosure may be practiced without limitation to these specific details. In this description, well known methods and structures have not been described in detail so as not to unnecessarily obscure the present disclosure. Various features and standards of 4G and 5G operation and inter-generational

interoperability are briefly discussed herein, to more accurately describe deficiencies of the current conditional operation (CHO, CPC, CPA) specifications.

### 3GPP Dual Connectivity

In 3GPP Rel-12, for the 4G Radio Access Network (RAN), called Long Term Evolution (LTE), the feature of Dual Connectivity (DC) was introduced, to enable the User Equipment (UE) to be connected in two cell groups, each controlled by an LTE access node, eNBs, labelled as the Master eNB (MeNB) and the Secondary eNB (SeNB). The UE still only has one Radio Resource Control (RRC) connection with the network. In 3GPP, the DC solution has since then been evolved and is now also specified for the 5G RAN, New Radio (NR), as well as between LTE and NR. Multi-connectivity (MC) is the case when there are more than two nodes involved. With introduction of 5G, the term MR-DC (Multi-Radio Dual Connectivity, see also 3GPP TS 37.340) was defined as a generic term for all DC options which includes at least one NR access node. Using the MR-DC generalized terminology, the UE is connected in a Master Cell Group (MCG), controlled by the Master Node (MN), and in a Secondary Cell Group (SCG) controlled by a Secondary Node (SN).

5G added a second frequency range, FR2. This provided significant new available spectrum in the range 24.25-52.6 GHZ. In this frequency range, beamforming is utilized to improve both coverage and capacity. Because the wavelengths are small at these high frequencies, antenna arrays with hundreds, or even thousands, of antenna elements are feasible.

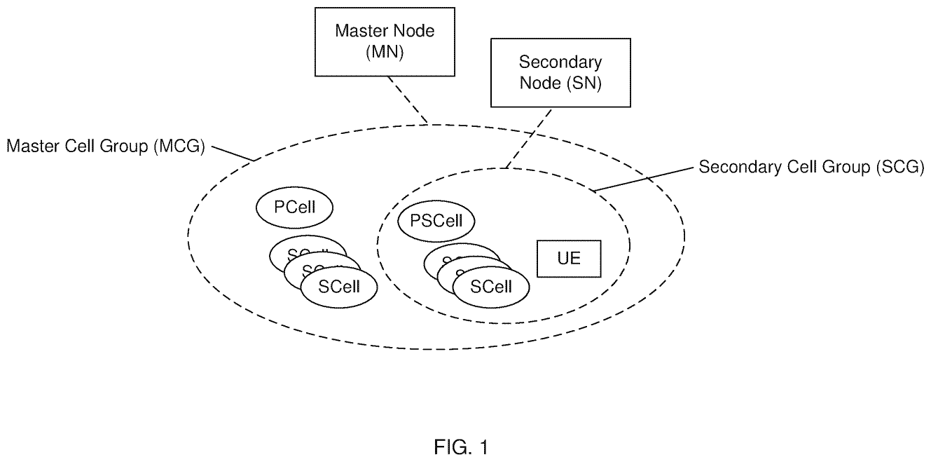

Further, in MR-DC, when dual connectivity is configured for the UE, within each of the two cell groups, MCG and SCG, carrier aggregation may be used as well. In this case, within the Master Cell Group (MCG) controlled by the master node (MN), the UE may use one Primary Cell (PCell) and one or more Secondary Cells (SCell). And within the Secondary Cell Group (SCG) controlled by the secondary node (SN), the UE may use one Primary SCell (PSCell, also known as the primary SCG cell in NR) and one or more SCell(s). This combined case is illustrated in FIG. 1. In NR, the primary cell of a master or secondary cell group is sometimes also referred to as the Special Cell (SpCell). Hence, the SpCell in the MCG is the PCell and the SpCell in the SCG is the PSCell.

There are different ways to deploy 5G network with or without interworking with LTE (also referred to as E-UTRA) and evolved packet core (EPC). In principle, NR and LTE can be deployed without any interworking, denoted by NR stand-alone (SA) operation, also known as Option 2. That is, the gNB in NR can be connected to 5G core network (5GC) and the eNB in LTE can be connected to EPC with no interconnection between the two, also known as Option 1.

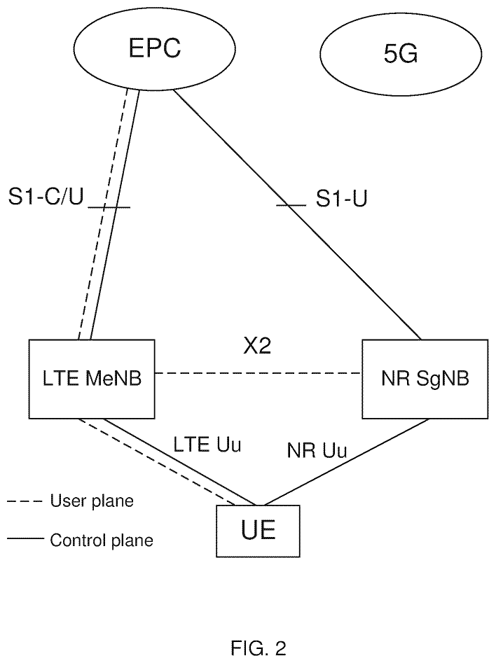

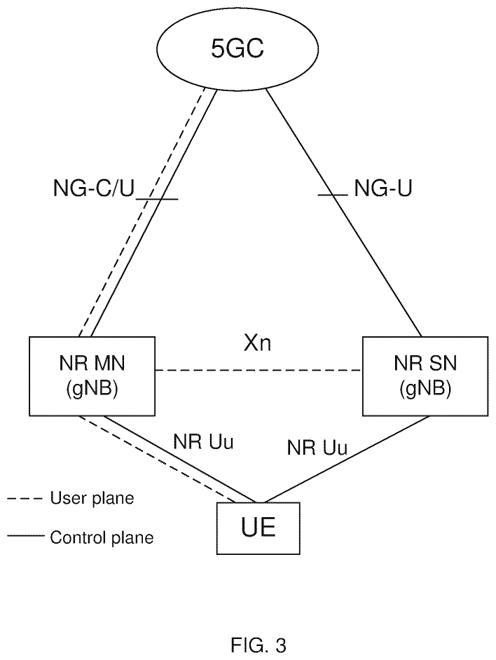

On the other hand, the first supported version of NR uses dual connectivity, denoted as EN-DC (E-UTRAN-NR Dual Connectivity), also known as Option 3, as depicted in FIG. 2. In such a deployment, dual connectivity between NR and LTE is applied, where the UE is connected with both the LTE radio interface (LTE Uu in the figure) to an LTE access node and the NR radio interface (NR Uu in the figure) to an NR access node. Further, in EN-DC, the LTE access node acts as the master node (in this case known as the Master eNB, MeNB), controlling the master cell group, MCG, and the NR access node acts as the secondary node (in this case sometimes also known as the Secondary gNB, SgNB), controlling the secondary cell group, SCG. The SgNB may not have a control plane connection to the core network (EPC) which instead is provided by the MeNB and in this case the NR. This is also called as “Non-standalone NR” or, in short, “NSA NR.” Notice that in this case the functionality of an NR cell is limited and would be used for connected mode UEs as a booster and/or diversity leg, but an RRC_IDLE UE cannot camp on these NR cells.

With the introduction of 5GC, other options may be also valid. As mentioned above, Option 2 supports stand-alone NR deployment where gNB is connected to 5GC. Similarly, LTE can also be connected to 5GC using Option 5 (also known as eLTE, E-UTRA/5GC, or LTE/5GC and the node can be referred to as an ng-eNB). In these cases, both NR and LTE are seen as part of the NG-RAN (and both the ng-eNB and the gNB can be referred to as NG-RAN nodes).

It is worth noting that there are also other variants of dual connectivity between LTE and NR which have been standardized as part of NG-RAN connected to 5GC. Under the MR-DC umbrella, there are:
EN-DC (Option 3): LTE is the master node and NR is the secondary node (EPC CN employed, as depicted in Error! Reference source not found.);
NE-DC (Option 4): NR is the master node and LTE is the secondary (5GCN employed);
NGEN-DC (Option 7): LTE is the master node and NR is the secondary (5GCN employed); and
NR-DC (variant of Option 2): Dual connectivity where both the master node, MN, controlling the MCG, and the secondary node, SN, controlling the SCG, are NR (5GCN employed, as depicted in Error! Reference source not found.).

### Conditional Handover (CHO)

In 3GPP Rel-16, the conditional handover was standardized as a solution to increase robustness at handover. In order to avoid the undesired dependence on the serving radio link upon the time (and radio conditions) where the UE should execute the handover, the possibility to provide RRC signaling for the handover to the UE earlier was standardized. It is possible to associate the HO command with a condition, e.g., based on radio conditions possibly similar to the ones associated to an A3 event, where a given neighbor becomes X dB better than target. As soon as the condition is fulfilled, the UE executes the handover in accordance with the provided handover command.

Such a condition could, e.g., be that the quality of the target cell or beam becomes X dB stronger than the serving cell. The threshold Y used in a preceding measurement reporting event should then be chosen lower than the one in the handover execution condition. This allows the serving cell to prepare the handover upon reception of an early measurement report and to provide the RRCConnectionReconfiguration with mobilityControlInfo (or the RRCReconfiguration with reconfigurationWithSync) at a time when the radio link between the source cell and the UE is still stable. The execution of the handover is done at a later point in time (and threshold), which is considered optimal for the handover execution.

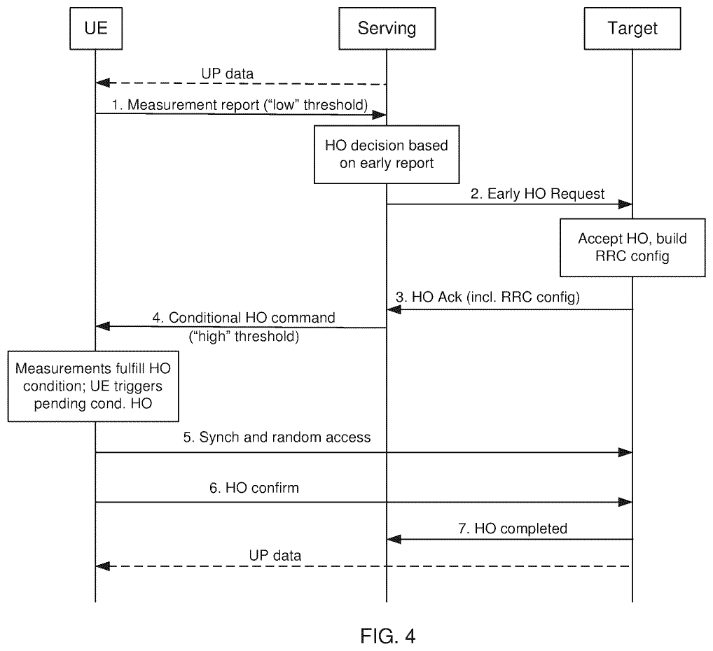

FIG. 4 depicts an example with just a serving and a target cell. In practice there may often be many cells or beams that the UE reported as possible candidates based on its preceding Radio Resource Management (RRM) measurements. The network should then have the freedom to issue conditional handover commands for several of those candidates. The RRCConnectionReconfiguration/RRCReconfiguration message for each of those candidates may differ not just concerning the target cell but also, e.g., in terms of the HO execution condition (Reference Signals, RS, to measure and threshold to exceed) as well as in terms of the Random Access (RA) preamble to be sent when a condition is met.

While the UE evaluates the condition, it continues operating per its current RRC configuration, i.e., without applying the conditional HO command. When the UE determines that the condition is fulfilled, it disconnects from the serving cell, applies the conditional HO command, and connects to the target cell. These steps are equivalent to the legacy handover execution.

When the UE has successfully performed the random access procedure towards the target cell during a conditional handover or a normal handover, it then releases all the conditional reconfigurations that it has stored. The target cell may then configure new conditional reconfigurations to the UE if it is considered useful.

### Conditional PSCell Change (CPC) in 3GPP Rel-16

A solution for Conditional PSCell Change (CPC) procedure was also standardized in Rel-16. Therein a UE operating in Multi-Radio Dual Connectivity (MR-DC) receives in a conditional reconfiguration one or multiple RRC Reconfiguration(s) (e.g., an RRCReconfiguration message) containing an SCG configuration (e.g., a secondaryCellGroup of IE CellGroupConfig) with a reconfigurationWithSync that is stored and associated to an execution condition (e.g., a condition like an A3/A5 event configuration), so that one of the stored messages is only applied upon the fulfillment of the execution condition, e.g., associated with the serving PSCell, upon which the UE would perform PSCell change (in case it finds a neighbor cell that is better than the current SpCell of the SCG). Only intra-SN CPC without MN involvement is standardized in 3GPP Rel-16, i.e., for cases where the (candidate) target PSCells are located in the current serving SN.

Similar to conditional handover, in case a random access was performed for a target PSCell and the UE was configured with CPC, the UE then releases all the conditional reconfigurations that it has stored.

### CPA and inter-SN CPC in 3GPP Rel-17

In 3GPP Rel-17, solutions for Conditional PSCell Addition (CPA) and inter-SN CPC are being discussed and introduced. The CPA procedure is used for adding a PSCell/SCG to the configuration for a UE that is currently only configured with an MCG, when associated execution conditions are fulfilled. CPA is initiated by the MN by requesting an SCG configuration, which is to be provided as part of a conditional reconfiguration to the UE, from a (candidate) target SN (T-SN), and then sending it in a conditional reconfiguration to the UE, together with the associated execution conditions.

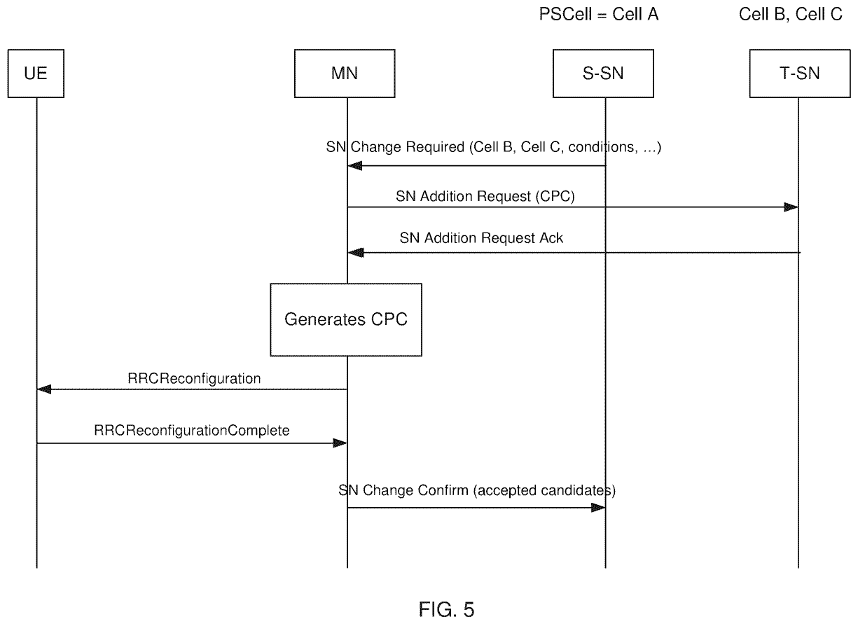

The inter-SN CPC can be initiated either by the MN or by the source SN (S-SN), where the signaling towards the source SN and the (candidate) target SNs, as well as towards the UE, in both cases is handled by the MN. One of the possible signaling sequences for configuration of an inter-SN CPC, which is initiated by the source SN, can be seen in the signaling flow in FIG. 5.

Also, for Rel-17 Conditional PSCell change (CPC)/Conditional PSCell addition (CPA), the UE configured with CPC/CPA releases the CPC/CPA configurations when completing random access towards the target PSCell.

### NR-DC with Selective Activation of the Cell Groups (at Least for SCG) via L3 Enhancements in 3GPP Rel-18

For 3GPP Rel-18, work is starting up to introduce enhancements for different mobility procedures, with a Work Item Description in RP-213565, New WI: Further NR mobility enhancements, MediaTek, 3GPP TSG RAN Meeting #94e, Dec. 6-17, 2021. One of the current objectives is “to specify mechanism and procedures of NR-DC with selective activation of the cell groups (at least for SCG) via L3 enhancements”, which includes “to allow subsequent cell group change after changing CG without reconfiguration and re-initiation of CPC/CPA”.

It should thus be possible to perform a subsequent cell group change after a first cell group change, without reconfiguring or re-initiation of Conditional PSCell Change (CPC) or Conditional PSCell Addition (CPA). This would then be done in order to reduce the interruption time and the signaling overhead for SCG changes, especially in the case of frequent SCG changes when operating in FR2 in NR, compared to when these configurations are released when the UE completes random access towards the target PSCell, as in the previous releases.

### CHO Including Target SCG

The 3GPP Rel-18 WID RP-213565 referenced above also contains an objective related to specifying CHO configuration including both target candidate MCG and target candidate SCG for CPAC (objective 4):

4. To specify CHO including target MCG and candidate SCGs for CPC/CPA in NR-DC [RAN3, RAN2]
CHO including target MCG and target SCG is used as the baseline

The WID in RP-213565 also includes the following justification related to the above objective:

Currently, CHO and MR-DC cannot be configured simultaneously. This limits the usefulness of these two features when MR-DC is configured. If it is not completed in Rel-17, Rel-18 should specify mechanisms for CHO and MR-DC to be configured simultaneously. However, this alone may not be sufficient to optimise MR-DC mobility, as the radio link quality of the conditionally-configured PSCell may not be good enough or may not be the best candidate PSCell when the UE accesses the target PCell, and this may impact the UE throughput. To mitigate this throughput impact, Rel-18 CHO+MRDC can consider CHO including target MCG and multiple candidate SCGs for CPC/CPA.

This means that a CHO configuration may contain CPC configurations. Or in another interpretation, CHO may be configured together with CPC for joint evaluation, where both conditions need to be fulfilled before both CHO and CPC are executed.

### Early or Late Compliance Check

In existing specifications, it is up to UE implementation whether to decode the entire RRC reconfiguration message when receiving a conditional reconfiguration such as CHO, CPC, or CPA, or whether to wait and decode the message that is applied when the conditions(s) are fulfilled, until the condition(s) are actually fulfilled and the message is actually executed. This is captured in the RRC specification TS 38.331 in the following note:

5.3.5.8.2 Inability to comply with RRCReconfiguration
[ . . . ]
NOTE 3: It is up to UE implementation whether the compliance check for an RRCReconfiguration received as part of ConditionalReconfiguration is performed upon the reception of the message or upon CHO, CPA and CPC execution (when the message is required to be applied).

The message that is applied is transmitted to the UE as part of the conditional reconfiguration, highlighted as underlined below:

### CondReconfig ToAddModList

The IE CondReconfigToAddModList concerns a list of conditional reconfigurations to add or modify, with for each entry the condReconfigld and the associated condExecutionCond/condExecutionCondSCG and condRRCReconfig.

CondReconfigToAddModList information element

-- ASN1START
-- TAG-CONDRECONFIGTOADDMODLIST-START

| | |
|---|---|
| CondReconfigToAddModList-r16 ::= | SEQUENCE (SIZE (1.. maxNrofCondCells- |

r16)) OF CondReconfigToAddMod-r16

| | |
|---|---|
| CondReconfigToAddMod-r16 ::= | SEQUENCE { |
| condReconfigId-r16 | CondReconfigId-r16, |
| condExecutionCond-r16 | SEQUENCE (SIZE (1..2)) OF MeasId |

OPTIONAL, -- Need M

| | |
|---|---|
| condRRCReconfig-r16 | OCTET STRING (CONTAINING |

| | |
|---|---|
| RRCReconfiguration) | OPTIONAL, -- Cond condReconfigAdd |

```
  ...,
  [[
```

| | |
|---|---|
| condExecutionCondSCG-r17 | OCTET STRING (CONTAINING |

| | |
|---|---|
| CondReconfigExecCondSCG-r17) | OPTIONAL -- Need M |

]]
}

| | |
|---|---|
| CondReconfigExecCondSCG-r17 ::= | SEQUENCE (SIZE (1..2)) OF MeasId |

-- TAG-CONDRECONFIGTOADDMODLIST-STOP
-- ASN1STOP

### Handover Command

The Handover Command is generated by a target node for handover or a target candidate node for conditional handover. It is sent to the source (currently serving) node and sent to the UE by the source node to initiate the transfer to the target node. The message generated by the target node is included as an OCTET STRING within the outer message sent to the source node.

### HandoverCommand

This message is used to transfer the handover command as generated by the target gNB. 1> Direction: target gNB to source gNB/source RAN.

-- ASN1START
-- TAG-HANDOVER-COMMAND-START

| | |
|---|---|
| HandoverCommand ::= | SEQUENCE { |
| criticalExtensions | CHOICE { |
| c1 | CHOICE{ |
| handoverCommand | HandoverCommand-IEs, |

```
        spare3 NULL, spare2 NULL, spare1 NULL
      },
```

| | |
|---|---|
| criticalExtensionsFuture | SEQUENCE { } |

}
}

| | |
|---|---|
| HandoverCommand-IEs ::= | SEQUENCE { |
| handoverCommandMessage | OCTET STRING (CONTAINING |

RRCReconfiguration),

| | |
|---|---|
| nonCriticalExtension | SEQUENCE { } |

OPTIONAL
}
-- TAG-HANDOVER-COMMAND-STOP
-- ASN1STOP

HandoverCommand field descriptions

handoverCommandMessage
Contains the RRCReconfiguration message used to perform handover
within NR or handover to NR, as generated (entirely) by the target gNB.

### Deficiencies with the Prior Art

There currently exist certain challenge(s) with conditional operations as defined in 3GPP. In order to support Conditional Handover (CHO) with candidate SCG configurations (using CPC/CPA) it is not clear how the target MN (for the CHO configuration) can provide CPC or CPA configurations to the UE where evaluations of the CPC/CPA configuration(s) are to be performed in parallel with evaluation of the CHO configuration. The execution conditions for the CHO configuration are set by the source MN whereas the execution conditions for the CPC or CPA would be provided by the target MN (or by an SN). In case the CHO configuration includes CPC or CPA configuration(s), it is then, e.g., not clear how the UE should determine to decode the CHO configuration already at configuration, in order to find the CPC/CPA configuration. Currently the CHO configuration cannot include any other conditional configuration, and the UE is only required to look for the target PCell identity within the CHO configuration when it receives the configuration.

Another issue concerns the order of execution of the CHO and CPC/CPA configurations when execution conditions are fulfilled for both at the same time, and both are to be executed. The CPC execution conditions will typically be fulfilled before the CHO execution conditions (because otherwise the CHO would be executed without the CPC configuration) and one could thus consider that the CPC configuration should be executed first. However, what configuration to execute first depends on whether one of the configurations is dependent/based on one of the others.

E.g., the CPC configuration may use the CHO configuration as a base and in that case, the CPC configuration should only be executed once the CHO configuration has been executed, or it could be based on the current MCG configuration that the UE has prior to CHO execution (and where the CHO configuration may, e.g., not impact the SCG configuration). It is thus not clear which configuration the UE should execute first if it determines that the conditional configurations are related and should both be executed.

In case the UE is configured with two conditional configurations, e.g., CHO and CPC, that are both to be executed, one of the conditional configurations may include changes to the other conditional configuration that mean that execution of both procedures would require, e.g., more signaling than if both configurations could be executed together. As an example, if the UE should execute both a CHO configuration, which includes a target MCG configuration and an SCG configuration, and a CPC configurations, which then corresponds to a changed SCG configuration (e.g., a different PSCell) compared to the SCG configuration in the CHO configuration, in case the UE first executes according to the CHO configuration and then executes according to the CPC configuration, it would, e.g., need to perform Random Access towards both PSCells/SCGs. The Random Access procedure towards the SCG/PSCell that was included in the CHO configuration would then have been done in vain.

### Terminology

This disclosure refers to a first network node operating as a Master Node (MN), e.g., having a Master Cell Group (MCG) configured to the UE; that MN can be a gNodeB, or a Central Unit gNodeB (CU-gNB) or an eNodeB, or a Central Unit eNodeB (CU-eNB), or any network node and/or network function. The disclosure also refers to a second network node operating as a Secondary Node (SN), or Source Secondary Node (S-SN) e.g., having a Secondary Cell Group (SCG) pre-configured (i.e., not connected to) to the UE; that SN can be a gNodeB, or a Central Unit gNodeB (CU-gNB) or an eNodeB, or a Central Unit eNodeB (CU-eNB), or any network node and/or network function. Notice that MN, S-SN and T-SN may be from the same or different Radio Access Technologies (and possibly be associated to different Core Network nodes).

The disclosure often refers to a “Secondary Node (SN)”, or target SN. This is synonymous with a target candidate SN, or a network node associated to a target candidate PSCell that is being configured. If the UE would connect to that cell, transmissions and receptions with the UE would be handled by that node if the cell is associated to that node.

The disclosure often refers to a Master Node (MN) that is a “target MN” or a “candidate target MN” or a “target candidate MN”, which corresponds to a network node associated to a target candidate PCell that is being configured. If the UE would connect to that cell, transmissions and receptions with the UE would be handled by that node if the cell is associated to that node. The disclosure often refers to a “source MN” which may correspond to a network node that is associated to a PCell that the UE is configured with before execution (and/or configuration) of a Handover or Conditional Handover procedure.

The disclosure states that a cell resides in a node, e.g., a target candidate cell resides in the S-SN or the t-SN. That is equivalent to a cell being managed by the node, or being associated to the node, or associated with the node, or that the cell belongs to the node, or that the cell is of the node.

“SN-initiated CPC” corresponds to a procedure wherein the Source SN for a UE configured with MR-DC determines to configure CPC. Upon determining the Source SN selects, e.g., based on reported measurements, one or more target candidate cells (target candidate PSCell(s)) wherein at least one cell is associated to the Source SN, and at least another cell is associated to a neighbor SN. If all target candidate cells are associated to the Source SN, that is an “SN-initiated intra-SN CPC”, which may be referred to as the Release 16 solution. If at least one target candidate cell is associated to a neighbor SN, that is an “SN-initiated inter-SN CPC”, which may be referred to as a Release 17 solution.

The disclosure refers to a candidate SN, or SN candidate, or an SN, as the network node (e.g., gNodeB) that is prepared during the CPA procedure and that can create an RRC Reconfiguration message with an SCG configuration (e.g., RRCReconfiguration**) to be provided to the UE and stored, with an execution condition, wherein the UE only applies the message upon the fulfillment of the execution condition. That candidate SN is associated to one or multiple PSCell candidate cell(s) with which the UE can be configured. The UE then can execute the condition and accesses one of these candidate cells, associated to a candidate SN that becomes the SN or simply the SN after execution (i.e., upon fulfillment of the execution condition).

The disclosure refers to a Conditional PSCell Change (CPC) configuration and procedures (like CPC execution), most of the time to refer to the procedure from the UE perspective. Other terms may be considered as synonyms, such as conditional reconfiguration, or Conditional Configuration (since the message that is stored and applied upon fulfillment of a condition is an RRCReconfiguration or RRCConnectionReconfiguration). Regarding terminology, conditional handover (CHO) may also be interpreted in a broader sense, also covering CPA (Conditional PSCell Change) procedures. The disclosure refers to a Conditional SN Change most of the time to refer to the procedure from the UE perspective, to refer to procedures between network nodes wherein a node requests a target candidate SN (which may be the same as the Source SN or a neighbour SN) to configure a conditional PSCell Change (CPC) for at least one of its associated cells (cell associated to the target candidate SN).

The disclosure refers to CPAC as either a Conditional PSCell Addition (CPA) or a Conditional PSCell Change (CPC).

The disclosure refers to a neighbor SN and a Source SN as different entities, though both could be a target candidate SN for CPC.

The configuration of CPC can be done using the same Information Elements (IEs) as conditional handover, which may be called at some point conditional configuration or conditional reconfiguration. The principle for the configuration is the same with configuring triggering/execution condition(s) and a reconfiguration message to be applied when the triggering condition(s) are fulfilled. The configuration IEs from 3GPP TS 38.331:

### ConditionalReconfiguration

The IE ConditionalReconfiguration is used to add, modify and release the configuration of conditional configuration.

### ConditionalReconfiguration Information Element

-- ASN1START
-- TAG-CONDITIONALRECONFIGURATION-START

| | |
|---|---|
| ConditionalReconfiguration-r16 ::= | SEQUENCE { |
| attemptCcondReconfig-r16 | ENUMERATED {true} |

OPTIONAL, -- Need N

| | |
|---|---|
| condConfigToRemoveList-r16 | CondConfigToRemoveList-r16 |

OPTIONAL, -- Need N

| | |
|---|---|
| condConfigToAddModList-r16 | CondConfigToAddModList-r16 |

```
    OPTIONAL, -- Need N
  ...
}
```

| | |
|---|---|
| CondConfigToRemoveList-r16 ::= | SEQUENCE (SIZE (1.. |

maxNrofCondCells)) OF CondConfigId-r16
-- TAG-CONDITIONALRECONFIGURATION-STOP
-- ASN1STOP

ConditionalReconfiguration field descriptions

condConfigToAddModList
List of the configuration of candidate SpCells to be added or modified for
CHO or CPC.
condConfigToRemoveList
List of the configuration of candidate SpCells to be removed. When the
network removes the stored conditional configuration for a candidate cell,
the network releases the measIDs associated to the condExecutionCond if
it is not used by the condExecutionCond of other candidate cells.

### CondConfigid

The IE CondConfigld is used to identify a CHO or CPC configuration.

### CondConfigld Information Element

-- ASN1START
-- TAG-CONDCONFIGID-START
CondConfigId-r16 ::= INTEGER (1.. maxNrofCond-Cells)
-- TAG-CONDCONFIGID-STOP
-- ASN1STOP

### CondConfigToAddModList

The IE CHO-ConfigToAddModList concerns a list of conditional configurations to add or modify, with for each entry the cho-Configld and the associated condExecutionCond and condRRCReconfig.

### CondConfigToAddModList Information Element

-- ASN1START
-- TAG-CONDCONFIGTOADDMODLIST-START

| | |
|---|---|
| CondConfigToAddModList-r16 ::= | SEQUENCE (SIZE (1.. |

maxNrofCondCells)) OF CondConfigToAddMod-r16

| | |
|---|---|
| CondConfigToAddMod-r16 ::= | SEQUENCE { |
| condConfigId-r16 | CondConfigId- |

r16,

| | |
|---|---|
| condExecutionCond-r16 | SEQUENCE (SIZE |

(1..2)) OF MeasId OPTIONAL, -- Need S

| | |
|---|---|
| condRRCReconfig-r16 | OCTET STRING |

```
    (CONTAINING RRCReconfiguration) OPTIONAL, -- Need S
  ...
}
-- TAG-CONDCONFIGTOADDMODLIST-STOP
-- ASN1STOP
```

CondConfigToAddMod field descriptions

condExecutionCond
The execution condition that needs to be fulfilled in order to trigger the
execution of a conditional configuration. The field is mandatory present
when a condConfigId is being added. Otherwise, when the
condRRCReconfig associated to a condConfigId is being modified it is
optionally present and the UE uses the stored value if the field is absent.
condRRCReconfig
The RRCReconfiguration message to be applied when the condition(s) are
fulfilled. The field is mandatory present when a condConfigId is being
added. Otherwise, when the condExecutionCond associated to a
condConfigId is being modified it is optionally present and the UE uses
the stored value if the field is absent.

In the different aspects of the present disclosure, these IEs are used differently, e.g., sometimes generated by the MN, sometimes generated by the source SN, sometimes by a target candidate SN.

In the different aspects of the present disclosure, it is said the CPC is in MN format when the CPC configuration is not configured as an MR-DC configuration in mrdc-SecondaryCellGroup (as defined in 3GPP TS 38.331). In other words, the UE receives an RRCReconfiguration from the MN that may contain the mrdc-SecondaryCellGroup (e.g., in case the UE is also configured with an SCG MeasConfig for inter-SN CPC) but the CPC is not within that container. That means the IEs listed above (e.g., the IE ConditionalReconfiguration) are not included in mrdc-SecondaryCellGroup.

In the different aspects of the present disclosure, it is said the CPC is in SN format when the CPC configuration is configured as an MR-DC configuration in mrdc-SecondaryCellGroup (as defined in TS 38.331). In other words, the UE receives an RRCReconfiguration from the MN that may contain the mrdc-SecondaryCellGroup and the CPC is within that container. That means the IEs listed above (e.g., the IE ConditionalReconfiguration) are included in mrdc-SecondaryCellGroup (e.g., within a series of other nested IEs).

The execution conditions for conditional reconfigurations often comprise a single conditions, but currently (in Rel-17 specifications) up to two executions conditions may be configured for each conditional reconfiguration. More execution conditions may be added in later releases.

### Main Aspects

In different aspects of the present disclosure, the UE may receive CHO and CPC or CPA configurations, which are indicated as being related and to be evaluated in parallel. The relation may, e.g., correspond to that the conditional configurations should be executed together in case execution conditions for both are fulfilled at the same time, and/or that only of the conditional configuration should be executed if the execution conditions for both are fulfilled at the same time, and/or that one of the conditional configurations should not be executed, even if the corresponding execution conditions are fulfilled, in case the execution conditions for the other conditional configuration are not fulfilled.

In case the UE determines that two conditional configurations are to be executed together, e.g., a CHO and a CPC configuration or a CHO and a CPA configuration, it is however not clear which of the configurations to execute first. The different conditional configurations may however be based on another configuration, and it therefore needs to be clear in what order they are to be performed.

One aspect comprises a method executed by a User Equipment (UE), the method comprising one or multiple and any combination of the following steps:

Receiving at least two different types of conditional configurations, e.g. a CHO configuration and a CPC or CPA configuration.
In one example, the CPC or CPA configuration is received within the CHO configuration, i.e. as part of the target configuration that is to be applied at fulfilment of the execution conditions for the corresponding CHO configuration
In one example, the message is received from a source MN, e.g. an RRCReconfiguration message, which contains a configuration for Conditional Handover (CHO) and configuration(s) for CPC or CPA,.
In one example, the CPC/CPA configuration(s) is/are included within the CHO configuration, i.e. within the RRCReconfiguration message that is included in condRRCReconfig of the CHO configuration and that thus is to be applied for the CHO execution when the CHO execution conditions are fulfilled.
In one example, the configuration for Conditional Handover (CHO) is contained in one message and the configuration(s) for CPC or CPA is contained in another message.
In one option, the execution conditions and related measurement configurations for CPC or CPA are included within the CHO configuration together with the target configuration for CPC/CPA to be applied at fulfillment of the corresponding execution conditions. In one option, also the identity of the target PSCell for the corresponding CPC or CPA configuration is provided in the CHO configuration, i.e. outside the corresponding target configuration for CPC/CPA. That way the UE is not required to check part of the content of the CPC/CPA configuration to determine what PSCell the execution conditions concern.
In one option, the message also includes an indication that the CHO configuration contains CPC or CPA configuration(s).
In another option, the message includes an indication that the UE should decode the CHO configuration, including to check for any CPC or CPA configurations. In other words, that the UE should check the content of the CHO configuration to not just find the target PCell identity but also to see if it includes e.g. any CPC or CPA configurations.
In one option, the message includes an indication that the UE should decode the whole RRC reconfiguration message upon reception of the message.
In one example, an indication about order of execution for the different conditional configurations, e.g., between a CHO configuration and a CPC or CPA configuration, is also received.
   The indication could be a one bit indication, indicating which conditional reconfiguration should be executed first.
   Alternatively, each conditional reconfiguration could be associated with an order number, indicating the order in which the conditional reconfigurations should be executed. In one example, when the order numbers for two conditional configurations have the same value, it indicates that those conditional configurations may be executed in a combined or in a non-sequential (parallel) fashion.
   Alternatively, the indication could comprise a list of the order in which the conditional reconfigurations should be executed. The list could e.g. include the conditional reconfiguration identities, the condConfigld, or some other identity.
   Alternatively, the indication could be a reference from a conditional configuration to another (different) conditional configuration, indicating that those conditional configurations may be executed in a combined or in a non-sequential (parallel) fashion.
   Alternatively, the indication is implicit. For example, in case a certain CHO configuration does not include a reconfiguration of SCG and a certain CPC or CPA configuration does not include a configuration of the MCG, this implies that those CHO and CPC or CPA configurations may be executed in a combined or in a non-sequential (parallel) fashion. In one example, a Rel-16 CPC configuration may be executed in executed in a combined or in a non-sequential (parallel) fashion with a CHO configuration that does not include a reconfiguration of SCG.
   Alternatively, the indication tells the UE that the order of execution for the different conditional configurations is to be determined based on criteria related to the current serving cells (e.g. PCell and PSCell)

Decoding the received CHO configuration and check for any included CPC or CPA configurations.
In one option, the UE determines to decode the CHO configuration and check for any included CPC or CPA configurations based on that the received message included an indication that the CHO configuration contains CPC or CPA configuration(s), or based on an indication that UE should decode the whole CHO configuration at reception of the configuration or based on an indication that the UE should decode the whole RRC reconfiguration message upon reception of the message.
In another option, the UE determines to decode the CHO configuration, and check for any included CPC or CPA configurations, based on that the UE supports the combination of CHO and CPC or CPA configurations. In one alternative, the UE determines to decode the CHO configuration, and check for any included CPC or CPA configurations, based on that the UE supports the combination of CHO and CPC or CPA configurations where the evaluation of CHO and evaluation of CPC or CPA are performed in parallel, or based on that the UE supports the combination of CHO and CPC configurations where execution of both procedures are to be performed if execution conditions are fulfilled for both configurations. In one alternative, the UE determines to decode the CHO reconfiguration or the whole RRC reconfiguration message based on other UE capability (ies).
In an alternative to the above options, after decoding a CHO configuration that includes one or more CPC or CPA configuration(s), the UE also starts evaluation of (the executions conditions for) the included CPC or CPA configuration(s).
In an alternative to the above options, the UE performs compliance check of the conditional configuration at reception of the conditional configuration. In one example, the UE performs compliance check of the CHO configuration which may include CPC or CPA configuration(s). In one other example, the UE performs compliance check of the CHO configuration and of the included CPC or CPA configuration(s), if any.

Transmitting at least one response message to the network to confirm the configuration.
The message(s) may be RRCReconfigurationComplete message(s).

Evaluating execution conditions for more than one type of conditional configuration. This enables that both the CHO configuration and the CPC configuration can be applied at the same time. There is then no need to first perform one of the procedures, e.g., the CHO procedure, and then start evaluation of CPC or CPA to then change or add the PSCell/SCG configuration, which would delay the time until the UE has the desired MR-DC configuration.
During evaluation the UE may determine that execution conditions for more than one conditional configuration are fulfilled at the same time.
During evaluation the UE may determine that more than one conditional configurations are to be executed.
During evaluation the UE may determine the order of execution for the more than one conditional configurations.
In one alternative, in case one of the conditional configurations (condConfigB) is included within the other conditional configuration (condConfigA) the UE determines to first execute the outer conditional configuration (i.e. condConfigA) and then the inner conditional configuration (condConfigB). As an example, in case the CPC or CPA configuration to be executed is included within the CHO configuration to be executed, then the UE determines to first execute the procedure for the CHO configuration and then the procedure for the CPC or CPA configuration.
In one alternative, the UE determines which of the conditional configurations to execute first based on an indication that is received from the network. The indication may e.g. be received in a dedicated RRC message (e.g. the RRCReconfiguration message that included at least one of the conditional configurations) or through a broadcast message. In one example where execution conditions for CHO and CPC or CPA are fulfilled at the same time, the indication tells that the UE should first perform the CPC or CPA configuration and then the CHO configuration. In another example, the indication tells that the UE should first perform the CHO configuration and then the CPC or CPA configuration. In yet another example, the indication tells the UE that certain conditional configurations may be executed in a combined or in a non-sequential (parallel) fashion. And for example, the indication is part of a conditional configuration, such as a CHO, CPC, or CPA configuration. And for example, the indication is a list of references to conditional configurations for which a combined execution can be performed with the conditional configuration the indication is included in.
In one alternative, the UE determines to execute one of the conditional configurations based on the type of the configuration. In one example where execution conditions for CHO and CPC or CPA are fulfilled at the same time, the UE determines to first execute the CHO configuration (concerning the MCG) and then the CPC or CPA configuration (concerning the SCG).
In one alternative, the UE determines that conditional configurations may be executed in a combined or in a non-sequential (parallel) fashion. For example, in case a certain CHO configuration does not include a reconfiguration of SCG and a certain CPC or CPA configuration does not include a configuration of the MCG, the UE determines that those CHO and CPC or CPA configurations may be executed in a combined or in a non-sequential (parallel) fashion. In one example, the UE may determine that a Rel-16 CPC configuration may be executed in a combined or in a non-sequential (parallel) fashion with a CHO configuration that does not include a reconfiguration of SCG.
In one alternative, the UE determines whether to execute CHO or CPC/CPA first based on criteria related to the current serving cells (e.g. PCell and PSCell). In this alternative, the UE executes the most urgent conditional configuration first to avoid failures, such as radio link failure, of the MCG or SCG. In one example, the determination is by comparing the number of consecutive out-of-sync indications for the PCell and PSCell. For example, if the number of consecutive out-of-sync indications for the PSCell is greater than the number of consecutive out-of-sync indications for the PCell, the UE determines to first execute CPC or CPA and then execute CHO. In another example, the determination is by comparing measurement quantities (e.g. RSRP, RSRQ, SINR) of the PCell and PSCell frequencies, or comparing them with certain thresholds. For example, if a certain measurement quantity for the PCell is below the same type of certain measurement quantity for the

PSCell, the UE determines to first execute CHO and then execute CPC or CPA. Or for example, if a certain measurement quantity for the PCell is below a certain threshold and a certain measurement quantity for the PSCell is above a certain threshold, the UE determines to first execute CHO and then execute CPC or CPA. Or for example, if a certain measurement quantity for the PCell is above a certain threshold and a certain measurement quantity for the PSCell is above a certain threshold, the UE determines that certain CHO and CPC or CPA configurations may be executed in a combined or in a non-sequential (parallel) fashion.

Executing the conditional configuration(s)
In one alternative, the UE first executes CHO and then CPA or CPC.
In another alternative, the UE first executes CPA or CPC and then CHO.
In yet another alternative, the UE executes CHO only.
In yet another alternative, the UE executes CPA or CPC only.
In yet another alternative, the UE executes the conditional configurations in a combined fashion. In one example, the combined fashion comprising the UE executing the CHO and not performing any actions related to an SCG as result of the CHO execution (such as random access in the SCG), and then executing CPC or CPA. In this way, the UE skips an unnecessary step as the SCG will anyway be reconfigured because of the CPC or CPA performed after CHO execution.
   In one example, the UE does then not perform any actions related to the SCG that is included in mrdc-SecondaryCellGroup within the CHO configuration and instead executes the CPC or CPA configuration.
In yet another alternative, the UE executes the conditional configurations in a non-sequential (parallel) fashion. For example, a non-sequential (parallel) fashion comprising the UE starting to execute CHO and, before the CHO execution has finalized, the UE starting to execute CPC or CPA. Or for example, a non-sequential (parallel) fashion comprising the UE starting to execute CPC or CPA and, before the CPC or CPA execution has finalized, the UE starting to execute CHO.
In one alternative, the UE executes the conditional configurations according to an indication received from the network, e.g. within the RRC message that configured CHO and/or CPC.

In one aspect, the UE receives the configuration(s) for CPC or CPA, or parts of the configuration(s), from the source MN outside the CHO configuration.
In one example, the UE receives the full CPC or CPA configuration, i.e. including the execution conditions, the measurement configuration, possibly also the identity of the target PSCell for the corresponding CPC or CPA configuration, and the target CPC or CPA configuration, i.e. the configuration to be applied when the corresponding execution conditions for the CPC or CPA configuration are fulfilled, outside the CHO configuration.
In another example, the UE receives the execution conditions, the measurement configuration and possibly also the identity of the target PSCell for the corresponding CPC or CPA configuration outside the CHO configuration whereas the target CPC or CPA configuration, i.e. the configuration to be applied when the corresponding execution conditions for the CPC or CPA configuration are fulfilled, is included within the CHO configuration.
In one example, the UE receives an indication that the CHO configuration and the one or more CPC or CPA configuration(s) are related, e.g. so they should both be executed in case execution conditions for both are fulfilled at the same time or that only of the conditional configuration should be executed if the execution conditions for both are fulfilled at the same time or that one of the configurations should not be executed even if the corresponding execution conditions are fulfilled, in case the execution conditions for the other configuration are not fulfilled.

One aspect comprises a method executed by a source Master Node (MN), the method comprising:

Determining to configure Conditional Handover (CHO). The UE may be in dual connectivity, i.e. connected to both the MN and to an SN (Secondary Node).
Transmitting a request to configure CHO to a candidate target MN. In one example, the request includes an indication that the CHO configuration may, could, or should include also a Conditional PSCell Change (CPC) or Conditional PSCell Addition (CPA) configuration.
   The message may be an XnAP HANDOVER REQUEST message.
Receiving a response message from the candidate target MN, wherein the response message contains the configuration of CHO and CPC or CPA. In one example, the CPC or CPA configuration(s) is/are included within the target configuration for CHO, within the configuration that the UE is to apply for the CHO execution. The response message may be an XnAP HANDOVER REQUEST ACKNOWLEDGE message where the target configuration for CHO is included within the included RRC HandoverCommand message.
   In one option, the source MN also receives an indication from the candidate target MN that the provided CHO configuration also includes a CPC or CPA configuration.
   In one option, the source MN also receives an indication from the candidate target MN that the provided CHO configuration also includes a CPC or CPA configuration and the source MN then includes an indication that the CHO configuration includes a CPC or CPA configuration, or an indication that the UE should decode the whole CHO configuration after reception of the configuration, in the message that is sent to the UE to provide the CHO configuration.
Transmitting a message to the UE with the CHO configuration and the CPC or CPA configuration(s). In one example, the CPC or CPA configuration(s) is/are included within the target configuration for CHO, i.e. within the RRCReconfiguration message that is included in condRRCReconfig of the CHO configuration and that is to be applied for the CHO execution.
   In one example, the source MN includes in the message an indication that the CHO configuration includes a CPC or CPA configuration, or an indication that the UE should decode the whole CHO configuration at reception of the configuration, e.g. to look for CPC or CPA configurations, if any.

In another aspect, the candidate target MN provides the CPC or CPA configuration(s) separately in the message that is sent to the source MN, e.g. in the Handover Command message or in the XnAP HANDOVER REQUEST ACKNOWLEDGE message (but outside the CHO configuration). In one example, the source MN then sends the CHO and the CPC/CPA configurations to the UE with an indication the configurations are related.

In another aspects, the source MN receives an indication from the candidate target MN that the CHO configuration that is provided by the candidate target MN includes a CPC or CPA configuration and the source MN then extracts the included CPC or CPA configuration(s) and provides them to the UE outside the CHO configuration. In one example, the source MN then includes an indication to the UE that the CHO and CPC/CPA configurations are related.

One aspects comprises a method executed by a candidate target Master Node (MN), the method comprising:

Receiving a request for a Conditional Handover (CHO) from the source MN (i.e. the current serving MN). In one example, the request may include an indication that the CHO configuration may, could, or should include also a Conditional PSCell Change (CPC) or Conditional PSCell Addition (CPA) configuration.
The message may be an XnAP HANDOVER REQUEST message.

Determining to configure one or more CPC or CPA candidates together with the CHO configuration and initiating CPC or CPA configuration towards one or more candidate target SN(s). In response the candidate target MN may receive target SCG configuration(s) for the CPC or CPA configuration(s) from each candidate target SN.
In one example, the target MN determines to configure CPC or CPA together with the CHO configuration based on an indication received from the source MN.
In one example, the target MN determines to configure CPC or CPA together with the CHO configuration based on any combination of UE capabilities, O&M configuration, current UE configuration or current or predicted traffic demands for the UE.

Transmitting a response message to the source MN, wherein the response message contains the configuration of CHO and CPC or CPA. In one example, the CPC or CPA configuration(s) is/are included within the target configuration for CHO, e.g. within handoverCommandMessage, of the HandoverCommand message, which is included within an XnAP HANDOVER REQUEST ACKNOWLEDGE message, see background section for Handover Command. The execution conditions (and possibly measurement configuration) for the included CPC configuration(s) may be set by the T-MN or by an SN, e.g. the current serving SN or another SN.
In one example, the message also includes an indication that the CHO configuration includes a CPC or CPA configuration or an indication that the UE should decode the whole CHO configuration at reception of the configuration or an indication that the UE should decode the whole RRC reconfiguration message upon reception of the message.
In an another aspect, the candidate target MN includes the CPC or CPA configuration(s) in the message that is sent to the source MN outside the target configuration for CHO. In one example, the CPC or CPA configuration(s) are included within the

HandoverCommand message, but outside the handoverCommandMessage, see background section for Handover Command. In another example, the e.g. CPC or CPA configuration(s) are included within the XnAP HANDOVER REQUEST ACKNOWLEDGE message, but outside the HandoverCommand message.

In another aspect, the execution conditions, measurement configuration and/or target PSCell identity for the CPC configuration(s) that is/are to be evaluated together with the CHO configuration are provided outside the CHO configuration. In one alternative, the target configuration, i.e., the RRCReconfiguration that the UE shall apply at execution of the CPC configuration, is however included within the CHO configuration. It is then only the execution conditions, measurement configuration and/or target PSCell identity for the CPC configuration that is provided outside the CHO configuration. These alternatives can be applicable in the signaling from the target MN to the source/serving MN and/or in the signaling from the (source/serving) MN to the UE.

In another aspect, where the CPC (candidate target PSCell) evaluation is done before the related CHO execution, the CHO configuration includes a configuration for the current/serving SN (at the point in time of the CHO configuration) as initial SCG configuration after the CHO execution, e.g. included in mrdc-SecondaryCellGroup, and one or more CPC configurations for other candidate SCGs (e.g. for other candidate target SNs). The UE then evaluates the execution conditions for the included CPC configurations in parallel with the evaluation of the execution conditions for the CHO configuration.

If the execution conditions for any of the included CPC configurations are fulfilled when the execution conditions for CHO are fulfilled, the UE will then apply the CHO configuration together with included CPC configuration for which the execution conditions are fulfilled. In one example, the UE then first applies the “initial SCG configuration”, i.e. the SCG configuration that is included in the CHO execution, e.g. in mrdc-SecondaryCellGroup, and then the corresponding CPC configuration on top of that. In another example, the UE does then not apply the “initial SCG configuration”, if any, but instead applies the corresponding CPC configuration.

If the execution conditions are not fulfilled for any of the CPC configuration included in the CHO configuration, the UE instead applies the CHO configuration with the “initial SCG configuration”, i.e., the SCG configuration that is included in the CHO execution, e.g. in mrdc-SecondaryCellGroup, if any.

### Intra-SN CPC, within CHO Configuration, for Simultaneous Evaluation

The CHO configuration may include a SCG configuration, e.g., within mrdc-SecondaryCellGroup in the configuration to be applied at CHO execution. This SCG configuration will then be applied and executed on when the execution conditions for CHO are fulfilled. The SCG configuration may be for the same SN that the UE has a configuration for before the CHO execution and/or before receiving the CHO configuration, or it may be for a different SN. The SCG configuration that is included in the CHO configuration (e.g. within mrdc-SecondaryCellGroup) may in turn include a CPC configuration for intra-SN CPC, where this configuration is generated by the SN and thus is in SN format.

Aspects of the present disclosure comprise different methods to enable the UE to perform simultaneous evaluation for the CHO configuration and for intra-SN CPC configuration(s) included within that CHO configuration.

One aspect comprises a method executed by a Secondary Node (SN), the method comprising:

Receiving a message from an MN, wherein the message requests resources for allocation of resources for dual connectivity operation for a UE and wherein the message contains an indication that the request is part of a procedure for Conditional Handover (CHO). The MN may thus be a (candidate) target MN for the CHO procedure. The message may e.g. be an XnAP S-NODE ADDITION REQUEST message.
In one example, the message includes an indication that simultaneous evaluation of CHO and CPC can be used for the procedure.

Transmitting a response message to the MN with an SCG configuration that includes an intra-SN CPC configuration. The message may, e.g., be an XnAP S-NODE ADDITION REQUEST ACKNOWLEDGE message.
In one alternative the message includes an indication that the (SCG) configuration included in the message includes a CPC configuration.
In one alternative, the message includes an indication that the (SCG) configuration in the message includes a CPC configuration, and that evaluation of this CPC configuration can be performed simultaneously with evaluation of the CHO configuration.
In one alternative, the message includes an indication whether execution of the included CPC configuration can be combined, or performed in parallel to, the CHO configuration.
In one example, the message includes one or more of the execution conditions, the related measurement configurations and the target PSCell identity/-ies, for the included CPC configuration(s) outside the provided SCG configuration that includes the CPC configuration.

One embodiment comprises a method executed by a candidate target Master Node (MN), the method comprising:

Receiving a request for a Conditional Handover (CHO) from the source MN (i.e. the current serving MN). In one example, the request may include an indication that the CHO configuration may, could, or should include also a Conditional PSCell Change (CPC). The message may e.g. be an XnAP HANDOVER REQUEST message.
In one example, the message includes an indication that simultaneous evaluation of CHO and CPC can be used for the procedure.

Transmitting a request to an SN for an SCG configuration to be included in the CHO configuration. The message may e.g. be an XnAP S-NODE ADDITION REQUEST message.
The SN may be the same SN as the one that the UE has an SCG configuration with at the point in time of the CHO configuration (together with the MCG configuration with the source MN), or it may be a different SN.
In one example, the candidate target MN includes, in the message, an indication that simultaneous evaluation of CHO and CPC can be used for the procedure.

Receiving a response message from the SN, which contains a configuration to be included as SCG configuration in the CHO configuration. The message may e.g. be an XnAP

S-NODE ADDITION REQUEST ACKNOWLEDGE message.
In one alternative the message includes an indication that the (SCG) configuration included in the message includes a CPC configuration.
In one alternative, the message includes an indication that the (SCG) configuration included in the message includes a CPC configuration, and that evaluation of this CPC configuration can be performed simultaneously with evaluation of the CHO configuration.
In one alternative, the message includes an indication whether execution of the included CPC configuration can be combined, or performed in parallel to, the CHO configuration.
In one example, the message includes one or more of the execution conditions, the related measurement configurations, and the target PSCell identity/-ies, for the included CPC configuration(s) outside the provided SCG configuration that includes the CPC configuration.

Transmitting a response message to the source MN, wherein the response message contains the configuration of CHO configuration that includes the SCG configuration as received from the SN. In one example, the SCG configuration includes one or more intra-SN CPC configuration(s) as configured by the SN.
In one alternative the message includes an indication that the CHO configuration includes a CPC configuration.
In one alternative the message includes an indication that the SCG configuration within the CHO configuration includes a CPC configuration.
In one alternative the message includes an indication that the CHO configuration, or the SCG configuration within the CHO configuration, includes a CPC configuration, and that evaluation of this CPC configuration can be performed simultaneously with evaluation of the CHO configuration.
In one alternative the message includes an indication whether execution of the included CPC configuration can be combined, or performed in parallel to, the CHO configuration.
In one example, the message includes an indication that the UE should decode the whole CHO configuration, including the SCG configuration within the CHO configuration, at reception of the configuration or an indication that the UE should decode the whole RRC reconfiguration message upon reception of the message.
The indication(s) may e.g. be included directly within the XnAP HANDOVER REQUEST ACKNOWLEDGE message that is sent to the source MN, or within the target configuration for CHO, e.g. within handoverCommandMessage, of the HandoverCommand message of that message, see background section for Handover Command. In one example, one or more of the execution conditions, the related measurement configurations and the target PSCell identity/-ies, for the included CPC or CPA configuration(s) may be included separately in the message, i.e. outside the CHO configuration or within the CHO configuration but outside the included SCG configuration.

One embodiment comprises a method executed by a source Master Node (MN), the method comprising:

Determining to configure Conditional Handover (CHO). The UE may be in dual connectivity, i.e. connected to both the MN and to an SN (Secondary Node).

Transmitting a request to configure CHO to a candidate target MN. In one example, the request includes an indication that the CHO configuration may, could, or should include also a Conditional PSCell Change (CPC) or Conditional PSCell Addition (CPA) configuration.
The message may be an XnAP HANDOVER REQUEST message.

Receiving a response message from the candidate target MN, wherein the response message contains the configuration of CHO and CPC. In one example, the CPC configuration(s) is/are included within the target configuration for CHO, as part of the SCG configuration that is included within the CHO configuration that the UE is to apply for the CHO execution. The response message may be an XnAP HANDOVER REQUEST ACKNOWLEDGE message where the target configuration for CHO is included within the included RRC HandoverCommand message.
In one option, the message also includes an indication from the candidate target MN that the provided CHO configuration includes a CPC configuration or an indication that the SCG configuration within the CHO configuration includes a CPC configuration.
   In one alternative the message also includes an indication that evaluation of the included CPC configuration can be performed simultaneously with evaluation of the CHO configuration.
   In one alternative the message also includes an indication whether execution of the included CPC configuration can be combined, or performed in parallel to, the CHO configuration.
   In one example, the message includes an indication that the UE should decode the whole CHO configuration, including the SCG configuration within the CHO configuration, at reception of the configuration, or an indication that the UE should decode the whole RRC reconfiguration message upon reception of the message.
In one embodiment, one or more of the execution conditions, the related measurement configurations and the target PSCell identity/-ies, for the included CPC configuration(s) may be included separately in the message, i.e. outside the CHO configuration or within the CHO configuration but outside the included SCG configuration.

Transmitting a message to the UE with the CHO configuration and the CPC configuration(s). In one example, the CPC configuration(s) is/are included within the SCG configuration included in the target configuration for CHO, i.e. the configuration that is to be applied for the CHO execution.
In one alternative, the source MN includes in the message an indication that the CHO configuration includes a CPC or CPA configuration, or an indication that the UE should decode the whole CHO configuration at reception of the configuration, e.g. to look for CPC or CPA configurations, if any, or an indication that the UE should decode the whole RRC reconfiguration message upon reception of the message.
In one alternative the source MN includes one or more of the execution conditions, the related measurement configurations and the target PSCell identity/-ies, for the CPC configuration(s) included in the CHO configuration, separately, i.e. outside the CHO configuration.

One embodiment comprises a method executed by a User Equipment (UE), the method comprising one or multiple and any combination of the following steps:

Receiving a CHO configuration that includes an SCG configuration with one or more included CPC configurations, e.g. intra-SN CPC configurations.
In one option, the message also includes an indication that the CHO configuration contains CPC configuration(s).
In one option, the message includes an indication that the CHO configuration contains CPC configuration(s) within the SCG configuration that is included within the CHO configuration.
In another option, the message includes an indication that the UE should decode the CHO configuration, including to check for any CPC configurations. In other words, that the UE should check the content of the CHO configuration to not just find the target PCell identity but also to see if it includes e.g. any CPC or CPA configurations. In one example, the indication tells the UE that it should decode the SCG configuration within the CHO configuration, including to check for any CPC configurations there.
In one option, the message includes an indication that the UE should decode the whole RRC reconfiguration message upon reception of the message.
In one option, the message includes an indication that evaluation of the included CPC configuration can be performed simultaneously with evaluation of the CHO configuration.
In one option, the message includes an indication whether execution of the included CPC configuration can be combined, or performed in parallel to, the CHO configuration. Such combined or parallel execution could then be performed if execution conditions are fulfilled for both configurations.
In one option, one or more of the execution conditions and related measurement configurations for the CPC configuration(s) are included within the CHO configuration, but outside the SCG configuration in mrdc-SecondaryCellGroup within the CHO configuration. In one option, also the identity/-ies of the candidate target PSCell(s) for the corresponding CPC configurations is/are provided in the CHO configuration, but outside the corresponding SCG configuration where the CPC configuration is included. That way the UE is not required to check the content of the SCG configuration within the CH configuration to determine how to perform evaluation of the included CPC configuration(s).
In one option, one or more of the execution conditions and related measurement configurations for the CPC configuration(s) are included outside the CHO configuration. In one option, also the identity/-ies of the candidate target PSCell(s) for the corresponding CPC configurations is/are provided outside the CHO configuration. That way the UE is not required to check the content of the CHO configuration to determine how to perform evaluation of the included CPC configuration(s).

Decoding the received CHO configuration and check for any included CPC configurations in the SCG configuration included within the CHO configuration.
In one option, the UE determines to decode the CHO configuration and check for any included CPC configurations within the included SCG configuration based on that the received message included an indication that the CHO configuration contains CPC configuration(s), or an indication that the SCG configuration within the CHO configuration contains CPC configuration(s), or based on an indication that UE should decode the whole CHO configuration at reception of the configuration or based on an indication that the UE should decode the whole RRC reconfiguration message upon reception of the message.
In another option, the UE determines to decode the CHO configuration, and check for any included CPC or CPA configurations in the SCG configuration included within the CHO configuration, based on that the UE supports the combination of CHO and (intra-SN) CPC configurations. In one alternative, the UE determines to decode the CHO configuration, and check for any included CPC configurations in the SCG configuration included within the CHO configuration, based on that the UE supports the combination of CHO and CPC configurations where the evaluation of CHO and evaluation of CPC or CPA are performed in parallel, or based on that the UE supports the combination of CHO and CPC configurations where execution of both procedures are to be performed if execution conditions are fulfilled for both configurations. In one alternative, the UE determines to decode the CHO reconfiguration or the whole RRC reconfiguration message based on other UE capability (ies).
In an alternative to the above options, after decoding a CHO configuration that includes one or more intra-SN CPC configuration(s), the UE also starts evaluation of (the executions conditions for) those included CPC configuration(s).
In an alternative to the above options, the UE performs compliance check of the conditional configuration at reception of the conditional configuration. In one example, the UE performs compliance check of the CHO configuration which may include intra-SN CPC configuration(s). In one other example, the UE performs compliance check of the CHO configuration and of the included intra-SN CPC configuration(s), if any.

Transmitting at least one response message to the network to confirm the configuration.
The message(s) may be RRCReconfigurationComplete message(s).

Evaluating execution conditions for more than one type of conditional configuration. This enables that both the CHO configuration and the CPC configuration can be applied at the same time. There is then no need to first perform one of the procedures, e.g., the CHO procedure, and then start evaluation of CPC or CPA to then change or add the

PSCell/SCG configuration, which would delay the time until the UE has the desired MR-DC configuration.
During evaluation the UE may determine that execution conditions for more than one conditional configuration are fulfilled at the same time.
During evaluation the UE may determine that more than one conditional configurations are to be executed.
During evaluation the UE may determine the order of execution for the more than one conditional configurations.
In one alternative, in case one of the conditional configurations (condConfigB) is included within the other conditional configuration (condConfigA) the UE determines to first execute the outer conditional configuration (i.e. condConfigA) and then the inner conditional configuration (condConfigB). As an example, in case the CPC or CPA configuration to be executed is included within the CHO configuration to be executed, then the UE determines to first execute the procedure for the CHO configuration and then the procedure for the CPC or CPA configuration.
In one alternative, the UE determines which of the conditional configurations to execute first based on an indication that is received from the network. The indication may e.g. be received in a dedicated RRC message (e.g. the RRCReconfiguration message that included at least one of the conditional configurations) or through a broadcast message. In one example where execution conditions for CHO and CPC or CPA are fulfilled at the same time, the indication tells that the UE should first perform the CPC or CPA configuration and then the CHO configuration. In another example, the indication tells that the UE should first perform the CHO configuration and then the CPC or CPA configuration. In yet another example, the indication tells the UE that certain conditional configurations may be executed in a combined or in a non-sequential (parallel) fashion. And for example, the indication is part of a conditional configuration, such as a CHO, CPC, or CPA configuration. And for example, the indication is a list of references to conditional configurations for which a combined execution can be performed with the conditional configuration the indication is included in.
In one alternative, the UE determines to execute one of the conditional configurations based on the type of the configuration. In one example where execution conditions for CHO and CPC or CPA are fulfilled at the same time, the UE determines to first execute the CHO configuration (concerning the MCG) and then the CPC or CPA configuration (concerning the SCG).
In one alternative, the UE determines that conditional configurations may be executed in a combined or in a non-sequential (parallel) fashion. For example, in case a certain CHO configuration does not include a reconfiguration of SCG and a certain CPC or CPA configuration does not include a configuration of the MCG, the UE determines that those CHO and CPC or CPA configurations may be executed in a combined or in a non-sequential (parallel) fashion. In one example, the UE may determine that a Rel-16 CPC configuration may be executed in a combined or in a non-sequential (parallel) fashion with a CHO configuration that does not include a reconfiguration of SCG. In one example, the UE determines whether conditional configurations may be executed in a combined or in a non-sequential (parallel) fashion based on an indication from the network.
In one alternative, the UE determines whether to execute CHO or CPC/CPA first based on criteria related to the current serving cells (e.g. PCell and PSCell). In this alternative, the UE executes the most urgent conditional configuration first to avoid failures, such as radio link failure, of the MCG or SCG. In one example, the determination is by comparing the number of consecutive out-of-sync indications for the PCell and PSCell. For example, if the number of consecutive out-of-sync indications for the PSCell is greater than the number of consecutive out-of-sync indications for the PCell, the UE determines to first execute CPC or CPA and then execute CHO. In another example, the determination is by comparing measurement quantities (e.g. RSRP, RSRQ, SINR) of the PCell and PSCell frequencies, or comparing them with certain thresholds. For example, if a certain measurement quantity for the PCell is below the same type of certain measurement quantity for the PSCell, the UE determines to first execute CHO and then execute CPC or CPA. Or for example, if a certain measurement quantity for the PCell is below a certain threshold and a certain measurement quantity for the PSCell is above a certain threshold, the UE determines to first execute CHO and then execute CPC or CPA. Or for example, if a certain measurement quantity for the PCell is above a certain threshold and a certain measurement quantity for the PSCell is above a certain threshold, the UE determines that certain CHO and CPC or CPA configurations may be executed in a combined or in a non-sequential (parallel) fashion.

Executing the conditional configuration(s)
In one alternative, the UE first executes CHO and then CPA or CPC.
In another alternative, the UE first executes CPA or CPC and then CHO
In yet another alternative, the UE executes CHO only
In yet another alternative, the UE executes CPA or CPC only.
In yet another alternative, the UE executes the conditional configurations in a combined fashion. In one example, the combined fashion comprising the UE executing the CHO and not performing any actions related to an SCG as result of the CHO execution (such as random access in the SCG), and then executing CPC or CPA. In this way, the UE skips an unnecessary step as the SCG will anyway be reconfigured because of the CPC or CPA performed after CHO execution.
   In one example, the UE does then not perform any actions related to the SCG that is included in mrdc-SecondaryCellGroup within the CHO configuration and instead executes the CPC or CPA configuration.
In yet another alternative, the UE executes the conditional configurations in a non-sequential (parallel) fashion. For example, a non-sequential (parallel) fashion comprising the UE starting to execute CHO and, before the CHO execution has finalized, the UE starting to execute CPC or CPA. Or for example, a non-sequential (parallel) fashion comprising the UE starting to execute CPC or CPA and, before the CPC or CPA execution has finalized, the UE starting to execute CHO.
In one alternative, the UE executes the conditional configurations according to an indication received from the network, e.g. within the RRC message that configured CHO and/or CPC.

### Example Implementation

An example implementation in TS 38.331 is shown below. An indication is included in the conditional reconfiguration, indicating to the UE that it needs to decode the messages to be applied when the conditions are fulfilled already upon reception of the message. The messages that are applied when the conditions are fulfilled can be seen as OCTET STRING in the message. According to existing specification, the UE is not required to decode that part until the conditions are fulfilled.

CondReconfig ToAddModList

The IE CondReconfigToAddModList concerns a list of conditional reconfigurations to add or modify, with for each entry the condReconfigld and the associated condExecutionCond/condExecutionCondSCG and condRRCReconfig.

CondReconfigToAddModList information element

-- ASN1START
-- TAG-CONDRECONFIGTOADDMODLIST-START
CondReconfigToAddModList-r16 :: = SEQUENCE (SIZE (1.. maxNrofCondCells-r16)) OF
CondReconfigToAddMod-r16

| | |
|---|---|
| CondReconfigToAddMod-r16 ::= | SEQUENCE { |
| condReconfigId-r16 | CondReconfigId-r16, |
| condExecutionCond-r16 | SEQUENCE (SIZE (1..2)) OF Meas Id |

OPTIONAL, -- Need M

| | |
|---|---|
| condRRCReconfig-r16 | OCTET STRING (CONTAINING RRCReconfiguration) |

```
OPTIONAL, -- Cond condReconfigAdd
  ...,
  [[
```

| | |
|---|---|
| condExecutionCondSCG-r17 | OCTET STRING (CONTAINING CondReconfigExecCondSCG- |

```
r17) OPTIONAL -- Need M
  ]],
  [[
```

| | |
|---|---|
| decodeEmbeddedMessages | BOOLEAN |

]]
}

| | |
|---|---|
| CondReconfigExecCondSCG-r17 ::= | SEQUENCE (SIZE (1..2)) OF MeasId |

-- TAG-CONDRECONFIGTOADDMODLIST-STOP
-- ASN1STOP

CondReconfigToAddMod field descriptions

condExecutionCond
The execution condition that needs to be fulfilled in order to trigger the execution of a
conditional reconfiguration for CHO, CPA, intra-SN CPC without MN involvement or MN
initiated inter-SN CPC. When configuring 2 triggering events (Meas Ids) for a candidate cell,
network ensures that both refer to the same measObject. For CHO, if network configures
condEventD1 or condEventT1 for a candidate cell network configures a second triggering event
condEventA3, condEventA4 or condEventA5 for the same candidate cell. Network does not
configure both condEventD1 and condEventT1 for the same candidate cell.
condExecutionCondSCG
Contains execution condition that needs to be fulfilled in order to trigger the execution of a
conditional reconfiguration for SN initiated inter-SN CPC. The Meas Ids refer to the measConfig
associated with the SCG. When configuring 2 triggering events (Meas Ids) for a candidate cell,
network ensures that both refer to the same measObject. For each condReconfigurationId, the
network always configures either condExecutionCond or condExecutionCondSCG (not both).
condRRCReconfig
The RRCReconfiguration message to be applied when the condition(s) are fulfilled. The
RRCReconfiguration message contained in condRRCReconfig cannot contain the field
conditionalReconfiguration or the field daps-Config. For CPA and for CPC, the
RRCReconfiguration message contained in condRRCReconfig cannot contain the field scg-
State.
decodeEmbeddedMessages
This field indicates that the UE shall decode the message(s) that shall be applied when the
condition(s) are fulfilled already at configuration of CondReconfigToAddMod.

| Conditional | |
|---|---|
| Presence | Explanation |
| condReconfigAdd | The field is mandatory present when a condReconfigId |
| | is being added. Otherwise the field is optional, need |
| | M. |

### Methods and Apparatuses

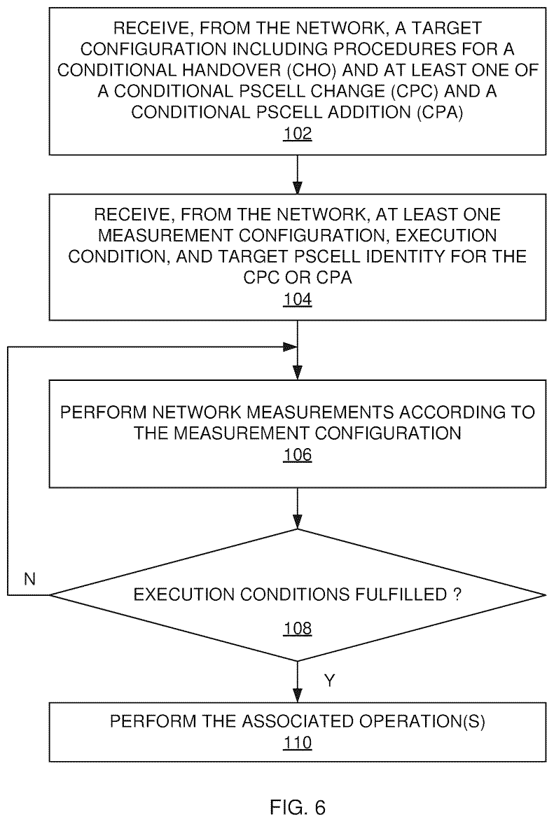

FIG. 6 depicts a method 100, performed by a wireless device operative in a wireless communication network, of performing multiple conditional operations. A target configuration including procedures for a Conditional Handover (CHO) and at least one of a Conditional PSCell Change (CPC) and a Conditional PSCell Addition (CPA) is received from the network (block 102). At least one measurement configuration, execution condition, and target PSCell identity for the CPC or CPA are received from the network (block 104). Network measurements are performed according to the measurement configuration (block 106). When the execution conditions are fulfilled (block 108), the associated operation(s) is/are performed (block 110).

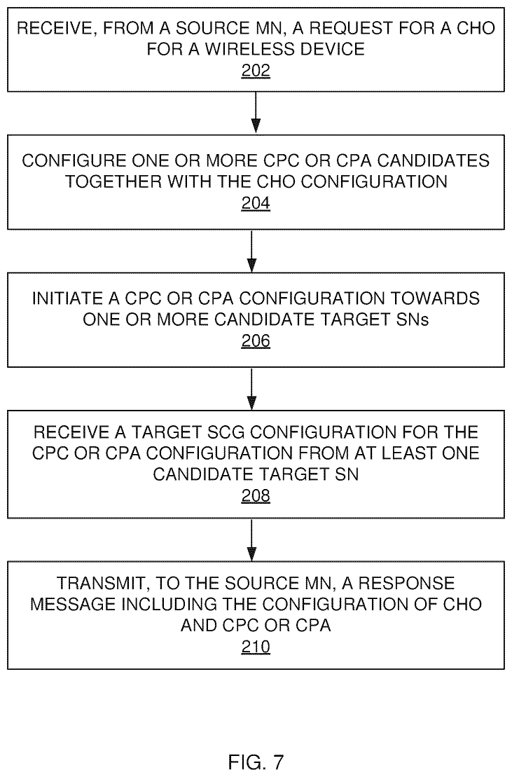

FIG. 7 depicts a method 200, performed by a network node operative in a wireless communication network, wherein the network node is a candidate target Master Node (MN). A request for a Conditional Handover (CHO) for a wireless device is received from a source MN (block 202). One or more Conditional PSCell Change (CPC) or Conditional PSCell Addition (CPA) candidates are configured together with the CHO configuration (block 204). A CPC or CPA configuration is initiated towards one or more candidate target Secondary Nodes (SN) (block 206). A target Secondary Cell Group (SCG) configuration for the CPC or CPA configuration is received from at least one candidate target SN (block 208). A response message including the configuration of CHO and CPC or CPA is transmitted to the source MN (block 210).

Apparatuses described herein may perform the methods 100, 200 herein and any other processing by implementing any functional means, modules, units, or circuitry. In one aspects of the disclosure, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several aspects of the disclosure. In aspects of the disclosure that employ memory, the memory stores program code that, when executed by the one or more processors, carries out the techniques described herein.

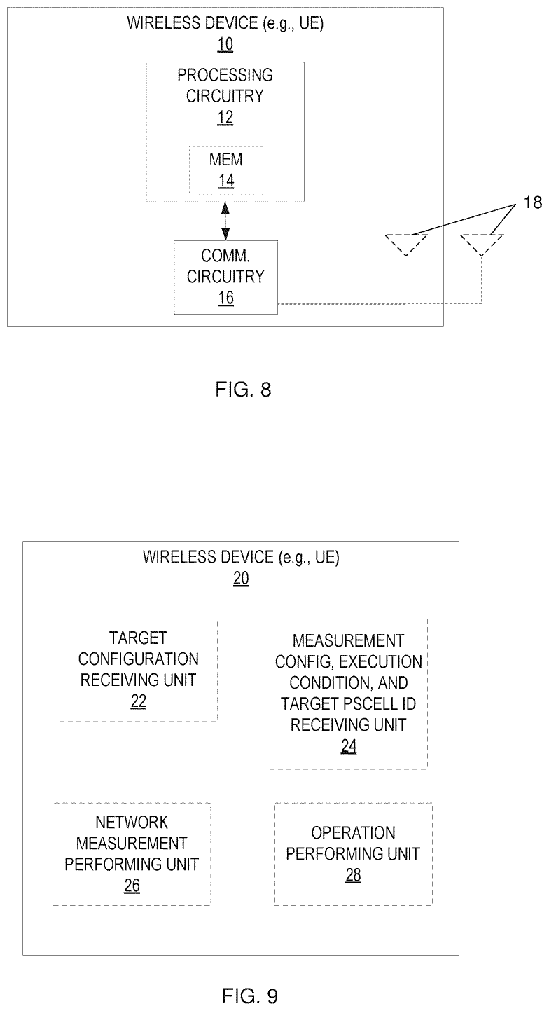

FIG. 8 for example illustrates a hardware block diagram of a wireless device 10 as implemented in accordance with one or more aspects of the disclosure. As shown, the wireless device 10 includes processing circuitry 14 and communication circuitry 18. The communication circuitry 18 (e.g., radio circuitry) is configured to transmit and/or receive information to and/or from one or more other nodes, e.g., via any communication technology. Such communication may occur via one or more antennas 20 that are either internal or external to the wireless device 10, as indicated by dashed lines. The processing circuitry 14 is configured to perform processing described above, such as by executing instructions stored in memory 16. The processing circuitry 14 in this regard may implement certain functional means, units, or modules.

FIG. 9 illustrates a functional block diagram of a wireless device 20 in a wireless network according to still other aspects of the disclosure. As shown, the wireless device 20 implements various functional means, units, or modules, e.g., via the processing circuitry 14 in FIG. 8 and/or via software code. These functional means, units, or modules, e.g., for implementing method 100 herein, include for instance: target configuration receiving unit 22; measurement config, execution condition, and target PSCell ID receiving unit 24; network measurement performing unit 26; and operation performing unit 28.

Target configuration receiving unit 22 is configured to receive, from the network, a target configuration including procedures for a Conditional Handover (CHO) and at least one of a Conditional PSCell Change (CPC) and a Conditional PSCell Addition (CPA). Measurement config, execution condition, and target PSCell ID receiving unit 24 is configured to receive, from the network, at least one measurement configuration, execution condition, and target PSCell identity for the CPC or CPA. Network measurement performing unit 26 is configured to perform network measurements according to the measurement configuration. When the execution conditions are fulfilled, operation performing unit 28 is configured to perform the associated operations.

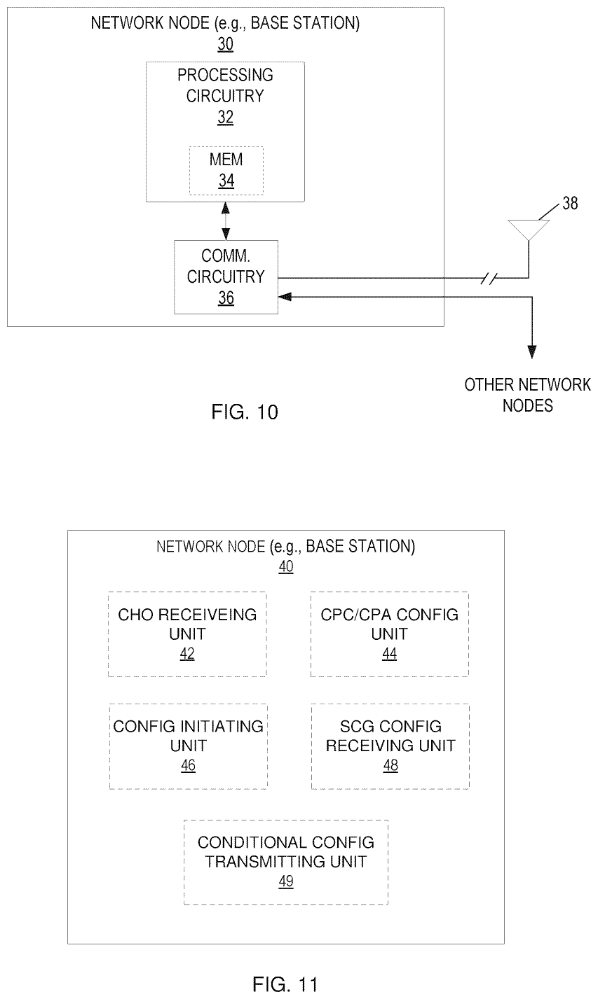

FIG. 10 illustrates a hardware block diagram of a network node 30 as implemented in accordance with one or more aspects of the disclosure. As shown, the network node 30 includes processing circuitry 32 and communication circuitry 36. The communication circuitry 36 is configured to transmit and/or receive information to and/or from one or more other nodes, e.g., via any communication technology. The network node 30 may function as a base station (e.g., eNB, gNB, etc.), and may wirelessly communicate with a plurality of wireless devices 10 via one or more antennas 38. As indicated by the broken line, the antennas 38 may be located remotely from the network node 30, such as on a tower or building. The processing circuitry 32 is configured to perform processing described above, such as by executing instructions stored in memory 34. Although represented as being within the network node 30, those of skill in the art understand that some or all of the processing circuitry 32 may be implemented as virtualized servers in a data center, e.g., in the so-called cloud. The processing circuitry 32 in this regard may implement certain functional means, units, or modules.

FIG. 11 illustrates a functional block diagram of a network node 40 in a wireless network according to still other aspects of the disclosure, in which the network node 40 is configured and/or operates as a candidate target Master Node (MN). As shown, the network node 40 implements various functional means, units, or modules, e.g., via the processing circuitry 32 in FIG. 10 and/or via software code. These functional means, units, or modules, e.g., for implementing the method(s) herein, include for instance: CHO receiving unit 42; CPC/CPA config unit 44; config initiating unit 46; SCG config receiving unit 48; and conditional config transmitting unit 49.

CHO receiving unit 42 is configured to receive, from a source MN, a request for a CHO for a wireless device. CPC/CPA config unit 44 is configured to configure one or more CPC or CPA candidates together with the CHO configuration. Config initiating unit 46 is configured to initiate a CPC or CPA configuration towards one or more candidate target Secondary Nodes (SN). SCG config receiving unit 48 is configured to receive a target SCG configuration for the CPC or CPA configuration from at least one candidate target SN. Conditional config transmitting unit 49 is configured to transmit, to the source MN, a response message including the configuration of CHO and CPC or CPA.

Those skilled in the art will also appreciate that aspects of the disclosure herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Aspects of the disclosure further include a carrier containing such a computer program. This carrier may comprise one of an electronic signal, optical signal, radio signal, or computer readable storage medium.

In this regard, aspects of the disclosure herein also include a computer program product stored on a non-transitory computer readable (storage or recording) medium and comprising instructions that, when executed by a processor of an apparatus, cause the apparatus to perform as described above.

Aspects of the disclosure further include a computer program product comprising program code portions for performing the steps of any of the aspects of the disclosure herein when the computer program product is executed by a computing device. This computer program product may be stored on a computer readable recording medium.

### NETWORK DESCRIPTION AND OVER THE TOP EMBODIMENTS

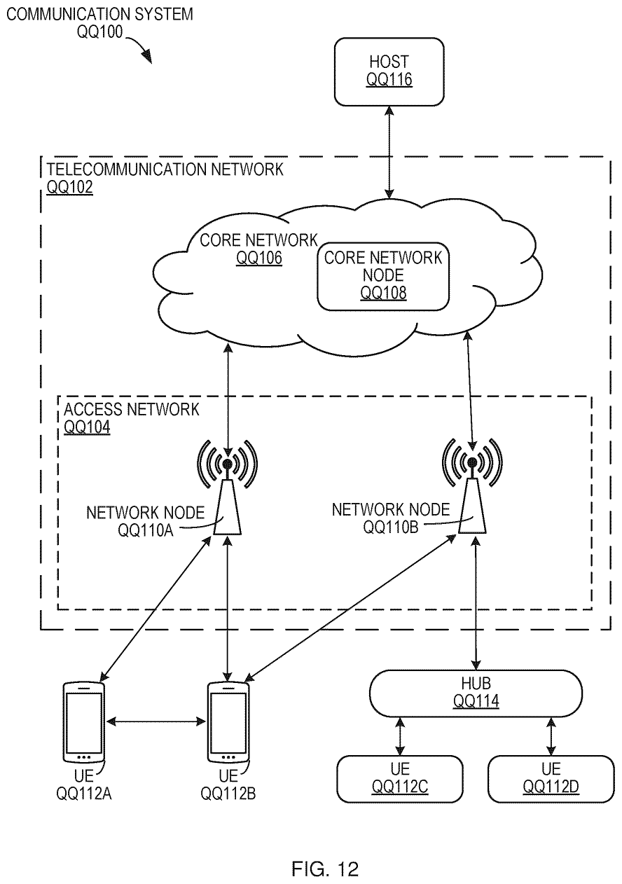

FIG. 12 shows an example of a communication system QQ100 in accordance with some embodiments.

In the example, the communication system QQ100 includes a telecommunication network QQ102 that includes an access network QQ104, such as a radio access network (RAN), and a core network QQ106, which includes one or more core network nodes QQ108. The access network QQ104 includes one or more access network nodes, such as network nodes QQ110a and QQ110b (one or more of which may be generally referred to as network nodes QQ110), or any other similar 3rd Generation Partnership Project (3GPP) access node or non-3GPP access point. The network nodes QQ110 facilitate direct or indirect connection of user equipment (UE), such as by connecting UEs QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of FIG. 12 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single-or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, the hub QQ114 communicates with the access network QQ104 to facilitate indirect communication between one or more UEs (e.g., UE QQ112c and/or QQ112d) and network nodes (e.g., network node QQ110b). In some examples, the hub QQ114 may be a controller, router, content source and analytics, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, network nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular in if one or more of the UEs are low energy IoT devices.

The hub QQ114 may have a constant/persistent or intermittent connection to the network node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection. In some scenarios, UEs may establish a wireless connection with the network nodes QQ110 while still connected via the hub QQ114 via a wired or wireless connection. In some embodiments, the hub QQ114 may be a dedicated hub-that is, a hub whose primary function is to route communications to/from the UEs from/to the network node QQ110b. In other embodiments, the hub QQ114 may be a non-dedicated hub-that is, a device which is capable of operating to route communications between the UEs and network node QQ110b, but which is additionally capable of operating as a communication start and/or end point for certain data channels.

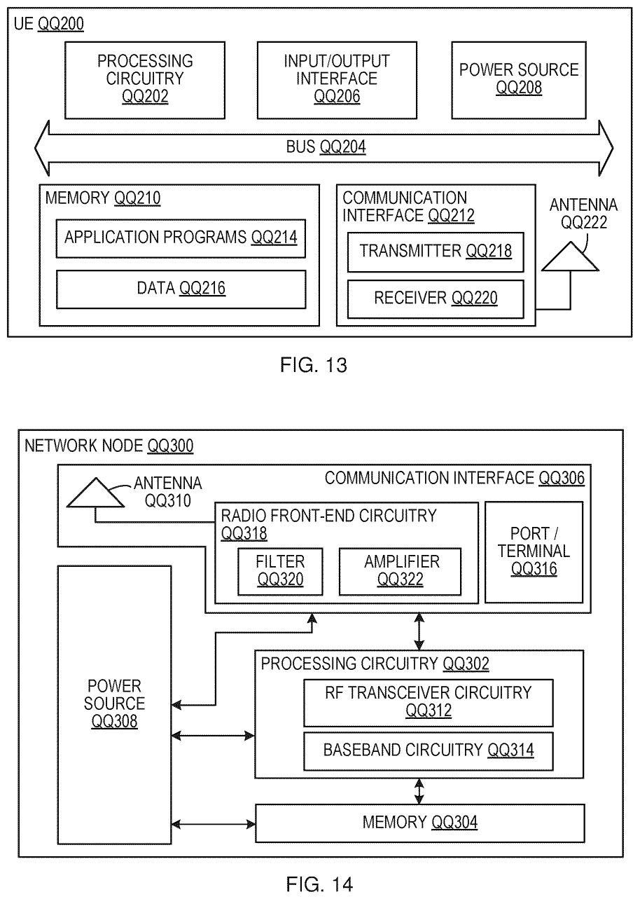

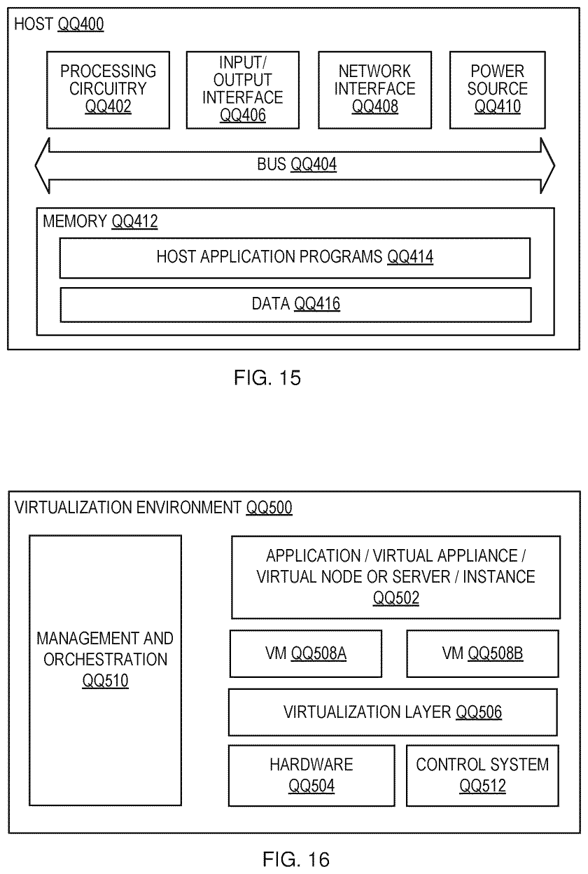

FIG. 13 shows a UE QQ200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer- premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE QQ200 includes processing circuitry QQ202 that is operatively coupled via a bus QQ204 to an input/output interface QQ206, a power source QQ208, a memory QQ210, a communication interface QQ212, and/or any other component, or any combination thereof. Certain UEs may utilize all or a subset of the components shown in FIG. 13. The level of integration between the components may vary from one UE to another UE. Further, certain UEs may contain multiple instances of a component, such as multiple processors, memories, transceivers, transmitters, receivers, etc.

The processing circuitry QQ202 is configured to process instructions and data and may be configured to implement any sequential state machine operative to execute instructions stored as machine-readable computer programs in the memory QQ210. The processing circuitry QQ202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry QQ202 may include multiple central processing units (CPUs).

In the example, the input/output interface QQ206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE QQ200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source QQ208 is structured as a battery or battery pack. Other types of power sources, such as an external power source (e.g., an electricity outlet), photovoltaic device, or power cell, may be used. The power source QQ208 may further include power circuitry for delivering power from the power source QQ208 itself, and/or an external power source, to the various parts of the UE QQ200 via input circuitry or an interface such as an electrical power cable. Delivering power may be, for example, for charging of the power source QQ208. Power circuitry may perform any formatting, converting, or other modification to the power from the power source QQ208 to make the power suitable for the respective components of the UE QQ200 to which power is supplied.

The memory QQ210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory QQ210 includes one or more application programs QQ214, such as an operating system, web browser application, a widget, gadget engine, or other application, and corresponding data QQ216. The memory QQ210 may store, for use by the UE QQ200, any of a variety of various operating systems or combinations of operating systems.

The memory QQ210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory QQ210 may allow the UE QQ200 to access instructions, application programs and the like, stored on transitory or non-transitory memory media, to off-load data, or to upload data. An article of manufacture, such as one utilizing a communication system may be tangibly embodied as or in the memory QQ210, which may be or comprise a device-readable storage medium.

The processing circuitry QQ202 may be configured to communicate with an access network or other network using the communication interface QQ212. The communication interface QQ212 may comprise one or more communication subsystems and may include or be communicatively coupled to an antenna QQ222. The communication interface QQ212 may include one or more transceivers used to communicate, such as by communicating with one or more remote transceivers of another device capable of wireless communication (e.g., another UE or a network node in an access network). Each transceiver may include a transmitter QQ218 and/or a receiver QQ220 appropriate to provide network communications (e.g., optical, electrical, frequency allocations, and so forth). Moreover, the transmitter QQ218 and receiver QQ220 may be coupled to one or more antennas (e.g., antenna QQ222) and may share circuit components, software, or firmware, or alternatively be implemented separately.

In the illustrated embodiment, communication functions of the communication interface QQ212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface QQ212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE QQ200 shown in FIG. 13.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 14 shows a network node QQ300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node QQ300 includes a processing circuitry QQ302, a memory QQ304, a communication interface QQ306, and a power source QQ308. The network node QQ300 may be composed of multiple physically separate components (e.g., a NodeB component and a RNC component, or a BTS component and a BSC component, etc.), which may each have their own respective components. In certain scenarios in which the network node QQ300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node QQ300 may be configured to support multiple radio access technologies (RATs). In such embodiments, some components may be duplicated (e.g., separate memory QQ304 for different RATs) and some components may be reused (e.g., a same antenna QQ310 may be shared by different RATs). The network node QQ300 may also include multiple sets of the various illustrated components for different wireless technologies integrated into network node QQ300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node QQ300.

The processing circuitry QQ302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ300 components, such as the memory QQ304, to provide network node QQ300 functionality.

In some embodiments, the processing circuitry QQ302 includes a system on a chip (SOC). In some embodiments, the processing circuitry QQ302 includes one or more of radio frequency (RF) transceiver circuitry QQ312 and baseband processing circuitry QQ314. In some embodiments, the radio frequency (RF) transceiver circuitry QQ312 and the baseband processing circuitry QQ314 may be on separate chips (or sets of chips), boards, or units, such as radio units and digital units. In alternative embodiments, part or all of RF transceiver circuitry QQ312 and baseband processing circuitry QQ314 may be on the same chip or set of chips, boards, or units.

The memory QQ304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry QQ302. The memory QQ304 may store any suitable instructions, data, or information, including a computer program, software, an application including one or more of logic, rules, code, tables, and/or other instructions capable of being executed by the processing circuitry QQ302 and utilized by the network node QQ300. The memory QQ304 may be used to store any calculations made by the processing circuitry QQ302 and/or any data received via the communication interface QQ306. In some embodiments, the processing circuitry QQ302 and memory QQ304 is integrated.

The communication interface QQ306 is used in wired or wireless communication of signaling and/or data between a network node, access network, and/or UE. As illustrated, the communication interface QQ306 comprises port(s)/terminal(s) QQ316 to send and receive data, for example to and from a network over a wired connection. The communication interface QQ306 also includes radio front-end circuitry QQ318 that may be coupled to, or in certain embodiments a part of, the antenna QQ310. Radio front-end circuitry QQ318 comprises filters QQ320 and amplifiers QQ322. The radio front-end circuitry QQ318 may be connected to an antenna QQ310 and processing circuitry QQ302. The radio front-end circuitry may be configured to condition signals communicated between antenna QQ310 and processing circuitry QQ302. The radio front-end circuitry QQ318 may receive digital data that is to be sent out to other network nodes or UEs via a wireless connection. The radio front-end circuitry QQ318 may convert the digital data into a radio signal having the appropriate channel and bandwidth parameters using a combination of filters QQ320 and/or amplifiers QQ322. The radio signal may then be transmitted via the antenna QQ310. Similarly, when receiving data, the antenna QQ310 may collect radio signals which are then converted into digital data by the radio front-end circuitry QQ318. The digital data may be passed to the processing circuitry QQ302. In other embodiments, the communication interface may comprise different components and/or different combinations of components.

In certain alternative embodiments, the network node QQ300 does not include separate radio front-end circuitry QQ318, instead, the processing circuitry QQ302 includes radio front-end circuitry and is connected to the antenna QQ310. Similarly, in some embodiments, all or some of the RF transceiver circuitry QQ312 is part of the communication interface QQ306. In still other embodiments, the communication interface QQ306 includes one or more ports or terminals QQ316, the radio front-end circuitry QQ318, and the RF transceiver circuitry QQ312, as part of a radio unit (not shown), and the communication interface QQ306 communicates with the baseband processing circuitry QQ314, which is part of a digital unit (not shown).

The antenna QQ310 may include one or more antennas, or antenna arrays, configured to send and/or receive wireless signals. The antenna QQ310 may be coupled to the radio front-end circuitry QQ318 and may be any type of antenna capable of transmitting and receiving data and/or signals wirelessly. In certain embodiments, the antenna QQ310 is separate from the network node QQ300 and connectable to the network node QQ300 through an interface or port.

The antenna QQ310, communication interface QQ306, and/or the processing circuitry QQ302 may be configured to perform any receiving operations and/or certain obtaining operations described herein as being performed by the network node. Any information, data and/or signals may be received from a UE, another network node and/or any other network equipment. Similarly, the antenna QQ310, the communication interface QQ306, and/or the processing circuitry QQ302 may be configured to perform any transmitting operations described herein as being performed by the network node. Any information, data and/or signals may be transmitted to a UE, another network node and/or any other network equipment.

The power source QQ308 provides power to the various components of network node QQ300 in a form suitable for the respective components (e.g., at a voltage and current level needed for each respective component). The power source QQ308 may further comprise, or be coupled to, power management circuitry to supply the components of the network node QQ300 with power for performing the functionality described herein. For example, the network node QQ300 may be connectable to an external power source (e.g., the power grid, an electricity outlet) via an input circuitry or interface such as an electrical cable, whereby the external power source supplies power to power circuitry of the power source QQ308. As a further example, the power source QQ308 may comprise a source of power in the form of a battery or battery pack which is connected to, or integrated in, power circuitry. The battery may provide backup power should the external power source fail. Embodiments of the network node QQ300 may include additional components

beyond those shown in FIG. 14 for providing certain aspects of the network node's functionality, including any of the functionality described herein and/or any functionality necessary to support the subject matter described herein. For example, the network node QQ300 may include user interface equipment to allow input of information into the network node QQ300 and to allow output of information from the network node QQ300. This may allow a user to perform diagnostic, maintenance, repair, and other administrative functions for the network node QQ300.

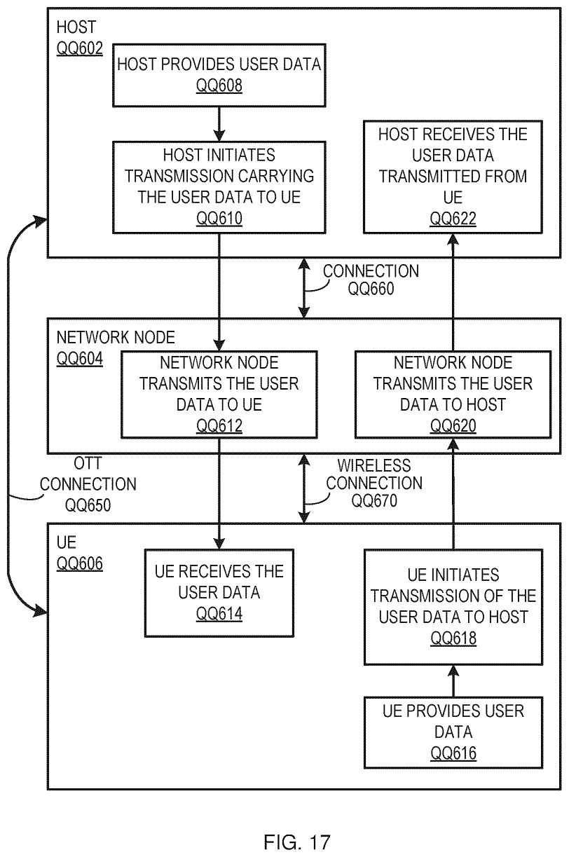

FIG. 16 is a block diagram of a host QQ400, which may be an embodiment of the host QQ116 of FIG. 12, in accordance with various aspects described herein. As used herein, the host QQ400 may be or comprise various combinations hardware and/or software, including a standalone server, a blade server, a cloud-implemented server, a distributed server, a virtual machine, container, or processing resources in a server farm. The host QQ400 may provide one or more services to one or more UEs.

The host QQ400 includes processing circuitry QQ402 that is operatively coupled via a bus QQ404 to an input/output interface QQ406, a network interface QQ408, a power source QQ410, and a memory QQ412. Other components may be included in other embodiments. Features of these components may be substantially similar to those described with respect to the devices of previous figures, such as Figures QQ2 and QQ3, such that the descriptions thereof are generally applicable to the corresponding components of host QQ400.

The memory QQ412 may include one or more computer programs including one or more host application programs QQ414 and data QQ416, which may include user data, e.g., data generated by a UE for the host QQ400 or data generated by the host QQ400 for a UE. Embodiments of the host QQ400 may utilize only a subset or all of the components shown. The host application programs QQ414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs QQ414 may also provide for user authentication and licensing checks and may periodically report health, routes, and content availability to a central node, such as a device in or on the edge of a core network. Accordingly, the host QQ400 may select and/or indicate a different host for over-the-top services for a UE. The host application programs QQ414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 17 is a block diagram illustrating a virtualization environment QQ500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments QQ500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications QQ502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors (VMMs)), provide VMs QQ508a and QQ508b (one or more of which may be generally referred to as VMs QQ508), and/or perform any of the functions, features and/or benefits described in relation with some embodiments described herein. The virtualization layer QQ506 may present a virtual operating platform that appears like networking hardware to the VMs QQ508.

The VMs QQ508 comprise virtual processing, virtual memory, virtual networking or interface and virtual storage, and may be run by a corresponding virtualization layer QQ506. Different embodiments of the instance of a virtual appliance QQ502 may be implemented on one or more of VMs QQ508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM QQ508 may be a software implementation of a physical machine that runs programs as if they were executing on a physical, non-virtualized machine. Each of the VMs QQ508, and that part of hardware QQ504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ508 on top of the hardware QQ504 and corresponds to the application QQ502.

Hardware QQ504 may be implemented in a standalone network node with generic or specific components. Hardware QQ504 may implement some functions via virtualization. Alternatively, hardware QQ504 may be part of a larger cluster of hardware (e.g. such as in a data center or CPE) where many hardware nodes work together and are managed via management and orchestration QQ510, which, among others, oversees lifecycle management of applications QQ502. In some embodiments, hardware QQ504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system QQ512 which may alternatively be used for communication between hardware nodes and radio units.

FIG. 18 shows a communication diagram of a host QQ602 communicating via a network node QQ604 with a UE QQ606 over a partially wireless connection in accordance with some embodiments. Example implementations, in accordance with various embodiments, of the UE (such as a UE QQ112a of FIG. 12 and/or UE QQ200 of FIG. 13), network node (such as network node QQ110a of FIG. 12 and/or network node QQ300 of FIG. 14), and host (such as host QQ116 of FIG. 12 and/or host QQ400 of FIG. 16) discussed in the preceding paragraphs will now be described with reference to FIG. 18.

Like host QQ400, embodiments of host QQ602 include hardware, such as a communication interface, processing circuitry, and memory. The host QQ602 also includes software, which is stored in or accessible by the host QQ602 and executable by the processing circuitry. The software includes a host application that may be operable to provide a service to a remote user, such as the UE QQ606 connecting via an over-the-top (OTT) connection QQ650 extending between the UE QQ606 and host QQ602. In providing the service to the remote user, a host application may provide user data which is transmitted using the OTT connection QQ650.

The network node QQ604 includes hardware enabling it to communicate with the host QQ602 and UE QQ606. The connection QQ660 may be direct or pass through a core network (like core network QQ106 of FIG. 12) and/or one or more other intermediate networks, such as one or more public, private, or hosted networks. For example, an intermediate network may be a backbone network or the Internet.

The UE QQ606 includes hardware and software, which is stored in or accessible by UE QQ606 and executable by the UE's processing circuitry. The software includes a client application, such as a web browser or operator-specific “app” that may be operable to provide a service to a human or non-human user via UE QQ606 with the support of the host QQ602. In the host QQ602, an executing host application may communicate with the executing client application via the OTT connection QQ650 terminating at the UE QQ606 and host QQ602. In providing the service to the user, the UE's client application may receive request data from the host's host application and provide user data in response to the request data. The OTT connection QQ650 may transfer both the request data and the user data. The UE's client application may interact with the user to generate the user data that it provides to the host application through the OTT connection QQ650.

The OTT connection QQ650 may extend via a connection QQ660 between the host QQ602 and the network node QQ604 and via a wireless connection QQ670 between the network node QQ604 and the UE QQ606 to provide the connection between the host QQ602 and the UE QQ606. The connection QQ660 and wireless connection QQ670, over which the OTT connection QQ650 may be provided, have been drawn abstractly to illustrate the communication between the host QQ602 and the UE QQ606 via the network node QQ604, without explicit reference to any intermediary devices and the precise routing of messages via these devices.

As an example of transmitting data via the OTT connection QQ650, in step QQ608, the host QQ602 provides user data, which may be performed by executing a host application. In some embodiments, the user data is associated with a particular human user interacting with the UE QQ606. In other embodiments, the user data is associated with a UE QQ606 that shares data with the host QQ602 without explicit human interaction. In step QQ610, the host QQ602 initiates a transmission carrying the user data towards the UE QQ606. The host QQ602 may initiate the transmission responsive to a request transmitted by the UE QQ606. The request may be caused by human interaction with the UE QQ606 or by operation of the client application executing on the UE QQ606. The transmission may pass via the network node QQ604, in accordance with the teachings of the embodiments described throughout this disclosure. Accordingly, in step QQ612, the network node QQ604 transmits to the UE QQ606 the user data that was carried in the transmission that the host QQ602 initiated, in accordance with the teachings of the embodiments described throughout this disclosure. In step QQ614, the UE QQ606 receives the user data carried in the transmission, which may be performed by a client application executed on the UE QQ606 associated with the host application executed by the host QQ602.

In some examples, the UE QQ606 executes a client application which provides user data to the host QQ602. The user data may be provided in reaction or response to the data received from the host QQ602. Accordingly, in step QQ616, the UE QQ606 may provide user data, which may be performed by executing the client application. In providing the user data, the client application may further consider user input received from the user via an input/output interface of the UE QQ606. Regardless of the specific manner in which the user data was provided, the UE QQ606 initiates, in step QQ618, transmission of the user data towards the host QQ602 via the network node QQ604. In step QQ620, in accordance with the teachings of the embodiments described throughout this disclosure, the network node QQ604 receives user data from the UE QQ606 and initiates transmission of the received user data towards the host QQ602. In step QQ622, the host QQ602 receives the user data carried in the transmission initiated by the UE QQ606.

One or more of the various embodiments improve the performance of OTT services provided to the UE QQ606 using the OTT connection QQ650, in which the wireless connection QQ670 forms the last segment. More precisely, the teachings of these embodiments may improve the robustness of mobility management and thereby provide benefits such as fewer dropped connections, reduced overhead by eliminating signaling required to rejoin the network, and improved user experience.

In an example scenario, factory status information may be collected and analyzed by the host QQ602. As another example, the host QQ602 may process audio and video data which may have been retrieved from a UE for use in creating maps. As another example, the host QQ602 may collect and analyze real-time data to assist in controlling vehicle congestion (e.g., controlling traffic lights). As another example, the host QQ602 may store surveillance video uploaded by a UE. As another example, the host QQ602 may store or control access to media content such as video, audio, VR or AR which it can broadcast, multicast or unicast to UEs. As other examples, the host QQ602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency, and other factors on which the one or more embodiments improve. There may further be an optional network functionality for reconfiguring the OTT connection QQ650 between the host QQ602 and UE QQ606, in response to variations in the measurement results. The measurement procedure and/or the network functionality for reconfiguring the OTT connection may be implemented in software and hardware of the host QQ602 and/or UE QQ606. In some embodiments, sensors (not shown) may be deployed in or in association with other devices through which the OTT connection QQ650 passes; the sensors may participate in the measurement procedure by supplying values of the monitored quantities exemplified above, or supplying values of other physical quantities from which software may compute or estimate the monitored quantities. The reconfiguring of the OTT connection QQ650 may include message format, retransmission settings, preferred routing etc.; the reconfiguring need not directly alter the operation of the network node QQ604. Such procedures and functionalities may be known and practiced in the art. In certain embodiments, measurements may involve proprietary UE signaling that facilitates measurements of throughput, propagation times, latency and the like, by the host QQ602. The measurements may be implemented in that software causes messages to be transmitted, in particular empty or ‘dummy’ messages, using the OTT connection QQ650 while monitoring propagation times, errors, etc.

Aspects of the present disclosure present numerous advantages over the prior art, and may provide one or more of the following technical advantage(s). Aspects of the present disclosure allow a wireless device to ascertain whether it needs to decode an embedded RRC message (for a conditional configuration) early, e.g., directly at reception of the configuration. This increases the flexibility of the configurations and decreases the execution time of an embedded conditional reconfiguration, e.g., a CPC configuration within a CHO configuration. A faster execution of CPC may lead to fewer failures of the SCG. A faster execution of CHO leads to fewer failures of the MCG and fewer re-establishments and connection interruptions. Aspects of the present disclosure also allow the UE to determine how to perform execution of two different conditional configurations that both fulfill execution conditions, and where both are to be executed.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### OTT EMBODIMENTS

### Group A Embodiments

1. A method, performed by User Equipment (UE) operative in a wireless communication network, of performing multiple conditional operations, comprising:
   receiving, from a network, at least two different types of configurations to conditionally perform an operation, each including execution conditions;
   if one of the received conditional configurations relates to a Conditional Handover (CHO), decoding the CHO configuration and ascertaining whether it includes
   a Conditional PSCell Change (CPC) or Conditional PSCell Addition (CPA) configuration;
   transmitting, to the network, at least one response message to confirm the configuration;
   evaluating network conditions against the execution conditions for each received conditional configuration; and
   if the execution conditions for at least one conditional configuration are satisfied, performing the associated operation(s).
2. The method of embodiment 1 wherein
   a received conditional configuration is a CHO configuration;
   a CPC or CPA configuration is received within the CHO configuration, wherein the CPC or CPA configuration is part of the target configuration that is to be applied at fulfilment of the execution conditions for the corresponding CHO configuration.
3. The method of embodiment 2 wherein the CPC or CPA configuration is included within a RRCReconfiguration message that is included in condRRCReconfig of the CHO configuration, whereby the CPC or CPA configuration is to be applied for the CHO execution when the CHO execution conditions are fulfilled
4. The method of embodiment 1 wherein the conditional configurations are received from a source Master Node (MN).
5. The method of embodiment 1 wherein a CHO configuration is received in one message and a CPC or CPA configuration is received in another message.
6. The method of embodiment 1 wherein the execution conditions and related measurement configurations for CPC or CPA are included within the CHO configuration together with the target configuration for CPC or CPA to be applied at fulfillment of the corresponding execution conditions.
7. The method of embodiment 6 wherein an identity of a target PSCell for the CPC or CPA configuration is provided in the CHO configuration and outside the corresponding target configuration for CPC/CPA, whereby the UE is not required to check part of the content of the CPC/CPA configuration to determine what PSCell the execution conditions relate to.
8. The method of embodiment 1 wherein a received message including a CHO configuration also includes an indication that the CHO configuration contains a CPC or CPA configuration.
9. The method of embodiment 1 wherein a received message including a CHO configuration also includes an indication that the UE should decode the CHO configuration and check for any CPC or CPA configurations.
10. The method of embodiment 1 wherein a received message including a conditional configuration includes an indication that the UE should decode the entire message upon reception of the message.
11. The method of embodiment 1 wherein receiving at least two different types of conditional configurations comprises further receiving an indication about order of execution for the different conditional configurations.
12. The method of embodiment 11 wherein the indication is one bit that indicates which conditional reconfiguration should be executed first.
13. The method of embodiment 11 wherein each conditional reconfiguration is associated with an order number, indicating the order in which the conditional reconfigurations should be executed.
14. The method of embodiment 13 wherein two conditional configurations have the order number, which indicates that those conditional configurations may be executed non-sequentially.
15. The method of embodiment 11 wherein the indication comprises a list of the order in which the conditional reconfigurations should be executed.
16. The method of embodiment 11 wherein the indication comprises a reference from a first conditional configuration to different second conditional configuration, indicating that the first and second conditional configurations may be executed in non-sequentially.
17. The method of embodiment 11 wherein the indication indicates that the order of execution for the different conditional configurations is to be determined based on criteria related to the current serving cells.
18. The method of embodiment 1 wherein an order of execution for the different conditional configurations is implicitly indicated.
19. The method of embodiment 18 wherein a CHO configuration does not include a reconfiguration of Secondary Cell Group (SCG) and a CPC or CPA configuration does not include a configuration of the Master Cell Group (MCG), which implies that the CHO and CPC or CPA configurations may be executed non-sequentially.
20. The method of embodiment 1, further comprising, after decoding a CHO configuration, performing a compliance check of the CHO configuration.
21. The method of embodiment 20, further comprising performing a compliance check of any CPC or CPA configuration included in the CHO configuration.
22. The method of embodiment 1, wherein transmitting a response message to the network comprises transmitting a RRCReconfigurationComplete message.
23. The method of embodiment 1, wherein evaluating network conditions against the execution conditions for each received conditional configuration comprises evaluating execution conditions for each configuration simultaneously.
24. The method of embodiment 1 wherein evaluating network conditions against the execution conditions for each received conditional configuration comprises determining that execution conditions for more than one conditional configuration are fulfilled at the same time.
25. The method of embodiment 1 wherein evaluating network conditions against the execution conditions for each received conditional configuration comprises determining that that more than one conditional configurations are to be executed.
26. The method of embodiment 1 wherein evaluating network conditions against the execution conditions for each received conditional configuration comprises determining the order of execution for the more than one conditional configurations.
27. The method of embodiment 1 wherein a first conditional configuration is included within a second conditional configuration, and further comprising determining to first execute the second conditional configuration and then the first conditional configuration.
28. The method of embodiment 1 wherein the conditional configurations include a CHO and CPC or CPA, and further comprising determining whether to execute the CHO or the CPC or CPA first based on criteria related to the current serving cells.
29. The method of embodiment 28 wherein the determining whether to execute the CHO or the CPC or CPA first based on criteria related to the current serving cells comprises executing the conditional configuration first that will prevent radio link failure.
30. The method of embodiment 29 wherein the determination of preventing radio link failure is based on comparing the number of consecutive out-of-sync indications for the associated serving cells.
31. The method of embodiment 1 wherein performing the associated operation comprises executing the CHO first and then the CPA or CPC.
32. The method of embodiment 1 wherein performing the associated operation comprises executing the CHO first and then the CPA or CPC.
33. The method of embodiment 1 wherein performing the associated operation comprises executing the CPA or CPC first and then the CHO.
34. The method of embodiment 1 wherein performing the associated operation comprises executing the CHO only.
35. The method of embodiment 1 wherein performing the associated operation comprises executing the CPA or CPC only.
36. The method of embodiment 1 wherein performing the associated operation comprises executing a CHO and not performing any actions related to a Secondary Cell Group (SCG) as result of the CHO execution, and then executing a CPC or CPA.
37. The method of embodiment 1 wherein not performing any actions related to an SCG as result of the CHO execution comprises not performing any actions related to the SCG that is included in mrdc-SecondaryCellGroup within the CHO configuration.
38. The method of embodiment 1 wherein receiving conditional configurations comprises part or all of a CPC or CPA configuration from the source Master Node (MN) outside of a received CHO configuration.
39. The method of embodiment 1 wherein receiving conditional configurations comprises receiving execution conditions and a measurement condition associated with each received conditional configuration.
40. The method of embodiment 39 wherein receiving conditional configurations further comprises receiving an identity of a target PSCell for a corresponding CPC or CPA configuration.
41. The method of embodiment 1 wherein receiving conditional configurations comprises:
   receiving execution conditions and a measurement configuration for a corresponding CPC or CPA configuration outside the CHO configuration; and
   receiving an indication of the configuration to be applied when the corresponding execution conditions for the CPC or CPA configuration are fulfilled, included within the CHO configuration.
42. The method of any of the previous embodiments, further comprising:
   providing user data; and
   forwarding the user data to a host via the transmission to the network node.

### Group B Embodiments

43. A method, performed by network node operative in a wireless communication network, wherein the network node is a candidate target Master Node (MN), comprising:
   receiving, from a source MN, a request for a Conditional Handover (CHO) for a User Equipment (UE);
   configuring one or more Conditional PSCell Change (CPC) or Conditional PSCell Addition (CPA) candidates together with the CHO configuration;
   initiating a CPC or CPA configuration towards one or more candidate target Secondary Nodes (SN);
   receiving a target Secondary Cell Group (SCG) configuration for the CPC or CPA configuration from at least one candidate target SN; and
   transmitting, to the source MN, a response message including the configuration of CHO and CPC or CPA.
44. The method of embodiment 43 wherein the request from the source MN for the CHO indicates that the CHO includes a CPC or CPA configuration.
45. The method of embodiment 44 wherein the request from the source MN for the CHO is an XnAP HANDOVER REQUEST message.
46. The method of embodiment 43 wherein configuring CPC or CPA together with the CHO configuration is done in response to an indication received from the source MN.
47. The method of embodiment 43 wherein configuring CPC or CPA together with the CHO configuration is done in response to any combination of UE capabilities, O&M configuration, current UE configuration, and current or predicted traffic demands for the UE.
48. The method of embodiment 44 wherein transmitting a response message including the configuration of CHO and CPC or CPA comprises transmitting the CPC or CPA configuration included within the CHO configuration.
49. The method of embodiment 48 wherein the CPC or CPA configuration is include within handoverCommandMessage, of the HandoverCommand message, which is included within an XnAP HANDOVER REQUEST ACKNOWLEDGE message.
50. The method of embodiment 48 wherein the execution conditions for the CPC or CPA configuration are set by one of the target MC and an SN.
51. The method of embodiment 43 wherein the response message includes an indication that the CHO configuration includes a CPC or CPA configuration.
52. The method of embodiment 43 wherein the response message includes an indication that the UE should decode the entire CHO configuration at reception of the configuration.
53. The method of embodiment 43 wherein the response message includes an indication that the UE should decode the entire RRC reconfiguration message upon reception of the message.
54. The method of embodiment 43 wherein the response message includes the CPC or CPA configuration outside the target configuration for CHO.
55. The method of embodiment 54 wherein the CPC or CPA configuration is included within the HandoverCommand message, but outside the handoverCommandMessage. 56. The method of embodiment 55 wherein the CPC or CPA configuration is included within the XnAP HANDOVER REQUEST ACKNOWLEDGE message, but outside the HandoverCommand message.
57. The method of embodiment 43 wherein execution conditions, a measurement configuration, or target PSCell identity for the CPC configuration that is to be evaluated together with the CHO configuration is provided outside the CHO configuration.
58. The method of embodiment 57 wherein the RRCReconfiguration that the UE shall apply at execution of the CPC configuration, is included within the CHO configuration.
59. The method of any of the previous embodiments, further comprising: obtaining user data; and forwarding the user data to a host or a user equipment.

### Group C Embodiments

60. A user equipment for performing multiple conditional operations, comprising: processing circuitry configured to perform any of the steps of any of the Group A embodiments; and power supply circuitry configured to supply power to the processing circuitry.
61. A network node comprising:
   processing circuitry configured to perform any of the steps of any of the Group B embodiments;
   power supply circuitry configured to supply power to the processing circuitry.
62. A user equipment (UE) for performing multiple conditional operations, the UE comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A embodiments;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE.
63. A host configured to operate in a communication system to provide an over-the-top (OTT) service, the host comprising:
   processing circuitry configured to provide user data; and
   a network interface configured to initiate transmission of the user data to a cellular network for transmission to a user equipment (UE),
   wherein the UE comprises a communication interface and processing circuitry, the communication interface and processing circuitry of the UE being configured to perform any of the steps of any of the Group A embodiments to receive the user data from the host.
64. The host of the previous embodiment, wherein the cellular network further includes a network node configured to communicate with the UE to transmit the user data to the UE from the host.
65. The host of the previous two embodiments, wherein:
   the processing circuitry of the host is configured to execute a host application, thereby providing the user data; and
   the host application is configured to interact with a client application executing on the UE, the client application being associated with the host application.
66. A method implemented by a host operating in a communication system that further includes a network node and a user equipment (UE), the method comprising:
   providing user data for the UE; and initiating a transmission carrying the user data to the UE via a cellular network comprising the network node, wherein the UE performs any of the operations of any of the Group A embodiments to receive the user data from the host.
67. The method of the previous embodiment, further comprising:
   at the host, executing a host application associated with a client application executing on the UE to receive the user data from the UE.
68. The method of the previous embodiment, further comprising:
   at the host, transmitting input data to the client application executing on the UE, the input data being provided by executing the host application,
   wherein the user data is provided by the client application in response to the input data from the host application.
69. A host configured to operate in a communication system to provide an over-the-top (OTT) service, the host comprising:
   processing circuitry configured to provide user data; and
   a network interface configured to initiate transmission of the user data to a cellular network for transmission to a user equipment (UE),
   wherein the UE comprises a communication interface and processing circuitry, the communication interface and processing circuitry of the UE being configured to perform any of the steps of any of the Group A embodiments to transmit the user data to the host.
70. The host of the previous embodiment, wherein the cellular network further includes a network node configured to communicate with the UE to transmit the user data from the UE to the host.
71. The host of the previous two embodiments, wherein:
   the processing circuitry of the host is configured to execute a host application, thereby providing the user data; and
   the host application is configured to interact with a client application executing on the UE, the client application being associated with the host application.
72. A method implemented by a host configured to operate in a communication system that further includes a network node and a user equipment (UE), the method comprising:
   at the host, receiving user data transmitted to the host via the network node by the UE, wherein the UE performs any of the steps of any of the Group A embodiments to transmit the user data to the host.
73. The method of the previous embodiment, further comprising:
   at the host, executing a host application associated with a client application executing on the UE to receive the user data from the UE.
74. The method of the previous embodiment, further comprising:
   at the host, transmitting input data to the client application executing on the UE, the input data being provided by executing the host application, wherein the user data is provided by the client application in response to the input data from the host application.
75. A host configured to operate in a communication system to provide an over-the-top (OTT) service, the host comprising:
   processing circuitry configured to provide user data; and
   a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.
76. The host of the previous embodiment, wherein:
   the processing circuitry of the host is configured to execute a host application that provides the user data; and
   the UE comprises processing circuitry configured to execute a client application associated with the host application to receive the transmission of user data from the host.
77. A method implemented in a host configured to operate in a communication system that further includes a network node and a user equipment (UE), the method comprising:
   providing user data for the UE; and
   initiating a transmission carrying the user data to the UE via a cellular network comprising the network node, wherein the network node performs any of the operations of any of the Group B embodiments to transmit the user data from the host to the UE.
78. The method of the previous embodiment, further comprising, at the network node, transmitting the user data provided by the host for the UE.
79. The method of any of the previous 2 embodiments, wherein the user data is provided at the host by executing a host application that interacts with a client application executing on the UE, the client application being associated with the host application.
80. A communication system configured to provide an over-the-top service, the communication system comprising:
   a host comprising:
   processing circuitry configured to provide user data for a user equipment (UE), the user data being associated with the over-the-top service; and
   a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.
81. The communication system of the previous embodiment, further comprising:
   the network node; and/or
   the user equipment.
82. A host configured to operate in a communication system to provide an over-the-top (OTT) service, the host comprising:
   processing circuitry configured to initiate receipt of user data; and
   a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.
83. The host of the previous two embodiments, wherein:
   the processing circuitry of the host is configured to execute a host application, thereby providing the user data; and
   the host application is configured to interact with a client application executing on the UE, the client application being associated with the host application.
84. The host of the any of the previous two embodiments, wherein the initiating receipt of the user data comprises requesting the user data.
85. A method implemented by a host configured to operate in a communication system that further includes a network node and a user equipment (UE), the method comprising:
   at the host, initiating receipt of user data from the UE, the user data originating from a transmission which the network node has received from the UE, wherein the network node performs any of the steps of any of the Group B embodiments to receive the user data from the UE for the host.
86. The method of the previous embodiment, further comprising at the network node, transmitting the received user data to the host.

In one aspect, the execution conditions, measurement configuration, and/or target PSCell identity for the CPC configuration(s) that is/are to be evaluated together with the CHO configuration are provided to the UE outside the CHO configuration. In one aspect, the target configuration, i.e., the RRCReconfiguration that the UE shall apply at execution of the CPC configuration, is however included within the CHO configuration. It is then only the execution conditions, measurement configuration, and/or target PSCell identity for the CPC configuration that is provided outside the CHO configuration.

Aspects of the present disclosure also include methods for the UE to determine the order of execution of different conditional configurations for which the execution conditions are fulfilled at the same time and where the procedures for both the configurations are to be executed, e.g., the order of execution of a CHO and a CPC or CPA procedure. In one example, the UE first executes the CHO configuration and then the CPC or CPA configuration (if the execution conditions have been fulfilled for any). This is for a case where the CPC/CPA configuration(s) are provided by the target MN of the CHO configuration, and thus can be assumed to be based on the target CHO configuration from that target MN. The CPC configuration could then possibly also include MCG updates, which could be a delta configuration based on the CHO configuration. However, it is also possible that the CPC configuration is based on the MCG configuration that the UE has before execution of the CHO configuration, e.g., in case the CPC configuration is set by the source MN. In that case, the UE should first execute the CPC configuration and then the CHO configuration (in which the SCG configuration, e.g., based on the executed CPC configuration, may be kept). In one aspect, the network provides an indication about what configuration to execute first. In another embodiment, the UE determines which configuration to execute first based on the method used to provide the different conditional configurations, e.g., whether the CPC or CPA configurations are provided within the CHO configuration (e.g., from the target MN) or outside the CHO configuration (e.g., from the source MN). In another aspect, the UE determines whether to execute CHO or CPC first based on criteria related to the current serving cells (e.g., PCell and PSCell).

In one aspect, the UE performs execution of CHO and CPA/CPC, in a combined or a non-sequential (parallel) fashion.

Aspects of the present disclosure also include methods for indicating that a conditional configuration is included within another conditional configuration between different network nodes, where the evaluation of the different conditional configurations are to be performed in parallel by the UE.

1-64. (canceled)

65. A method, performed by a wireless device operative in a wireless communication network, of performing multiple conditional operations, comprising:
receiving, from the network, a target configuration including procedures for a Conditional Handover (CHO) and at least one of a Conditional PSCell Change (CPC) and a Conditional PSCell Addition (CPA)
receiving, from the network, at least one measurement configuration, execution condition, and target PSCell identity for the CPC or CPA;
performing network measurements according to the measurement configuration; and
when the execution conditions are fulfilled, performing the associated operations.

66. The method of claim 65 wherein an order of execution for the conditional configurations is implicitly indicated.

67. The method of claim 66 wherein a CHO configuration does not include a reconfiguration of Secondary Cell Group (SCG) and a CPC or CPA configuration does not include a configuration of the Master Cell Group (MCG) which implies that the CHO and CPC or CPA configurations may be executed non-sequentially.

68. The method of claim 65, wherein determining when the execution conditions are fulfilled comprises evaluating execution conditions for each configuration simultaneously.

69. The method of claim 65 wherein determining when the execution conditions are fulfilled comprises determining that that more than one conditional configuration are to be executed.

70. The method of claim 65 wherein a first conditional configuration is included within a second conditional configuration, and further comprising determining to first execute the second conditional configuration and then the first conditional configuration.

71. The method of claim 65 wherein the conditional configurations include a CHO and CPC or CPA, and further comprising determining whether to execute the CHO or the CPC or CPA first based on criteria related to the current serving cells.

72. The method of claim 71 wherein determining whether to execute the CHO or the CPC or CPA first based on criteria related to the current serving cells comprises executing the conditional configuration first that will prevent radio link failure.

73. The method of claim 65 wherein a received conditional configuration is a CHO configuration;
a CPC or CPA configuration is received within the CHO configuration, wherein the CPC or CPA configuration is part of the target configuration that is to be applied at fulfilment of the execution conditions for the corresponding CHO configuration.

74. The method of claim 65 wherein receiving conditional configurations comprises:
receiving execution conditions and a measurement configuration for a corresponding CPC or CPA configuration outside the CHO configuration; and
receiving an indication of the configuration to be applied when the corresponding execution conditions for the CPC or CPA configuration are fulfilled, included within the CHO configuration.

75. A wireless device operative in a wireless communication network and capable of performing multiple conditional operations, comprising:
communication circuitry configured to communicate with the network; and
processing circuitry operatively connected to the communication circuitry, and configured to
receive, from the network, a target configuration including procedures for a Conditional Handover (CHO) and at least one of a Conditional PSCell Change (CPC) and a Conditional PSCell Addition (CPA) receive, from the network, at least one measurement configuration, execution condition, and target PSCell identity for the CPC or CPA;
perform network measurements according to the measurement configuration; and
when the execution conditions are fulfilled, perform the associated operations.

76. The wireless device of claim 75 wherein an order of execution for the different conditional configurations is implicitly indicated.

77. The wireless device of claim 76 wherein a CHO configuration does not include a reconfiguration of Secondary Cell Group (SCG) and a CPC or CPA configuration does not include a configuration of the Master Cell Group (MCG) which implies that the CHO and CPC or CPA configurations may be executed non-sequentially.

78. The wireless device of claim 75, wherein the processing circuitry is configured to determine when the execution conditions are fulfilled by evaluating execution conditions for each configuration simultaneously.

79. The wireless device of claim 75 wherein the processing circuitry is configured to determine when the execution conditions are fulfilled by determining that that more than one conditional configurations are to be executed.

80. The wireless device of claim 75 wherein a first conditional configuration is included within a second conditional configuration, and wherein the processing circuitry is further configured to determine to first execute the second conditional configuration and then the first conditional configuration.

81. The wireless device of claim 75 wherein the conditional configurations include a CHO and CPC or CPA, and wherein the processing circuitry is further configured to determine whether to execute the CHO or the CPC or CPA first based on criteria related to the current serving cells.

82. The wireless device of claim 81 wherein determining whether to execute the CHO or the CPC or CPA first based on criteria related to the current serving cells comprises executing the conditional configuration first that will prevent radio link failure.

83. The wireless device of claim 75 wherein
a received conditional configuration is a CHO configuration;
a CPC or CPA configuration is received within the CHO configuration, wherein the CPC or CPA configuration is part of the target configuration that is to be applied at fulfilment of the execution conditions for the corresponding CHO configuration.

84. The wireless device of claim 75 wherein the processing circuitry is configured to receive a target configuration by:
receiving execution conditions and a measurement configuration for a corresponding CPC or CPA configuration outside the CHO configuration; and
receiving an indication of the configuration to be applied when the corresponding execution conditions for the CPC or CPA configuration are fulfilled, included within the CHO configuration.

85. A method, performed by a network node operative in a wireless communication network, wherein the network node is a candidate target Master Node (MN) comprising:
receiving, from a source MN, a request for a Conditional Handover (CHO) for a wireless device;
configuring one or more Conditional PSCell Change (CPC) or Conditional PSCell Addition (CPA) candidates together with the CHO configuration;
initiating a CPC or CPA configuration towards one or more candidate target Secondary Nodes (SN);
receiving a target Secondary Cell Group (SCG) configuration for the CPC or CPA configuration from at least one candidate target SN; and
transmitting, to the source MN, a response message including the configuration of CHO and CPC or CPA.

86. A network node operative in a wireless communication network, and configured as a candidate target Master Node (MN) comprising:
communication circuitry configured to communicate with the network; and
processing circuitry operatively connected to the communication circuitry, and configured to
receive, from a source MN, a request for a Conditional Handover (CHO) for a wireless device;
configure one or more Conditional PSCell Change (CPC) or Conditional PSCell Addition (CPA) candidates together with the CHO configuration;
initiate a CPC or CPA configuration towards one or more candidate target Secondary Nodes (SN);
receive a target Secondary Cell Group (SCG) configuration for the CPC or CPA configuration from at least one candidate target SN; and
transmit, to the source MN, a response message including the configuration of CHO and CPC or CPA.
